(19) United States
(12) Patent Application Publication
(10) Pub. No.: US 2015/0143146 A1
(43) Pub. Date: May 21, 2015

(54) SUBSTRATE PROCESSING APPARATUS AND CONTROL METHOD

(71) Applicant: Kabushiki Kaisha Toshiba, Minato-ku (JP)

(72) Inventors: Hideo ETO, Yokkaichi (JP); Makoto SAITO, Nomi (JP)

(73) Assignee: Kabushiki Kaisha Toshiba, Minato-ku (JP)

(21) Appl. No.: 14/475,817

(22) Filed: Sep. 3, 2014

(30) Foreign Application Priority Data
Nov. 18, 2013 (JP) 2013-238062

(51) Int. Cl. G06F 1/32

(52) U.S. Cl. CPC G06F 1/3206
USPC 713/320

(57) ABSTRACT

According to one embodiment, there is provided a substrate processing apparatus including a substrate processing unit, a power supply, and a control unit. The substrate processing unit is configured to conduct processing on a substrate successively under first and second processing conditions each including a plurality of kinds of processing parameters to process the substrate. The power supply is capable of supplying power, which is one of the processing parameters included in each of the first and second processing conditions, to process the substrate. The control unit is configured to, during a period over which power supplied from the power supply is kept at a first level corresponding to the first processing condition, start a preparation operation to change over other processing parameters different from the power, from a level corresponding to the first processing condition to a level corresponding to the second processing condition.

### CROSS-REFERENCE TO RELATED APPLICATIONS

This application is based upon and claims the benefit of priority from Japanese Patent Application No. 2013-238062, filed on Nov. 18, 2013 which is incorporated herein by reference.

### FIELD

Embodiments described herein relate generally to a substrate processing apparatus and a control method.

### BACKGROUND

In manufacturing methods of semiconductor devices in recent years, cases where a multiplayer film is subjected to batch processing for the purpose of QTAT (Quick Turnaround Time) have increased. Especially in etching processing using plasma as in RIE (Reactive Ion Etching) processing, cases where a multiplayer film is subjected to batch processing continuously have increased. In the batch processing of a multilayer film, suitable processing conditions such as a gas flow rate, pressure, temperature and power are changed over successively from layer to layer. At this time, it is desired to shorten the changeover time of each processing condition in order to shorten total processing time of the multilayer film.

### BRIEF DESCRIPTION OF THE DRAWINGS

FIG. 1 is a diagram illustrating a configuration of a substrate processing apparatus according to a first embodiment;

FIG. 2 is a diagram illustrating a procedure of batch processing in the first embodiment;

FIG. 3 is a diagram illustrating correction of delay time in the first embodiment;

FIG. 4 is a diagram illustrating correction of delay time in the first embodiment;

FIG. 5 is a flow chart illustrating an operation of the substrate processing apparatus according to the first embodiment;

FIG. 6 is a diagram illustrating correction of delay time in a modification of the first embodiment;

FIG. 7 is a diagram illustrating a configuration of a substrate processing apparatus according to a second embodiment;

FIG. 8 is a diagram illustrating an acquisition method of delay time in the second embodiment;

FIG. 9 is a diagram illustrating a data structure of delay information in the second embodiment;

FIG. 10 is a flow chart illustrating an operation of a substrate processing apparatus according to the second embodiment;

FIG. 11 is a diagram illustrating a configuration of a substrate processing apparatus according to a third embodiment; and

FIG. 12 is a diagram illustrating a data structure of delay information in the third embodiment.

### DETAILED DESCRIPTION

In general, according to one embodiment, there is provided a substrate processing apparatus including a substrate processing unit, a power supply, and a control unit. The substrate processing unit is configured to conduct processing on a substrate successively under first and second processing conditions each including a plurality of kinds of processing parameters to process the substrate. The power supply is capable of supplying power, which is one of the processing parameters included in each of the first and second processing conditions, to process the substrate. The control unit is configured to, during a period over which power supplied from the power supply is kept at a first level corresponding to the first processing condition, start a preparation operation to change over other processing parameters different from the power, from a level corresponding to the first processing condition to a level corresponding to the second processing condition.

Exemplary embodiments of a substrate processing apparatus will be explained below in detail with reference to the accompanying drawings. The present invention is not limited to the following embodiments.

### First Embodiment

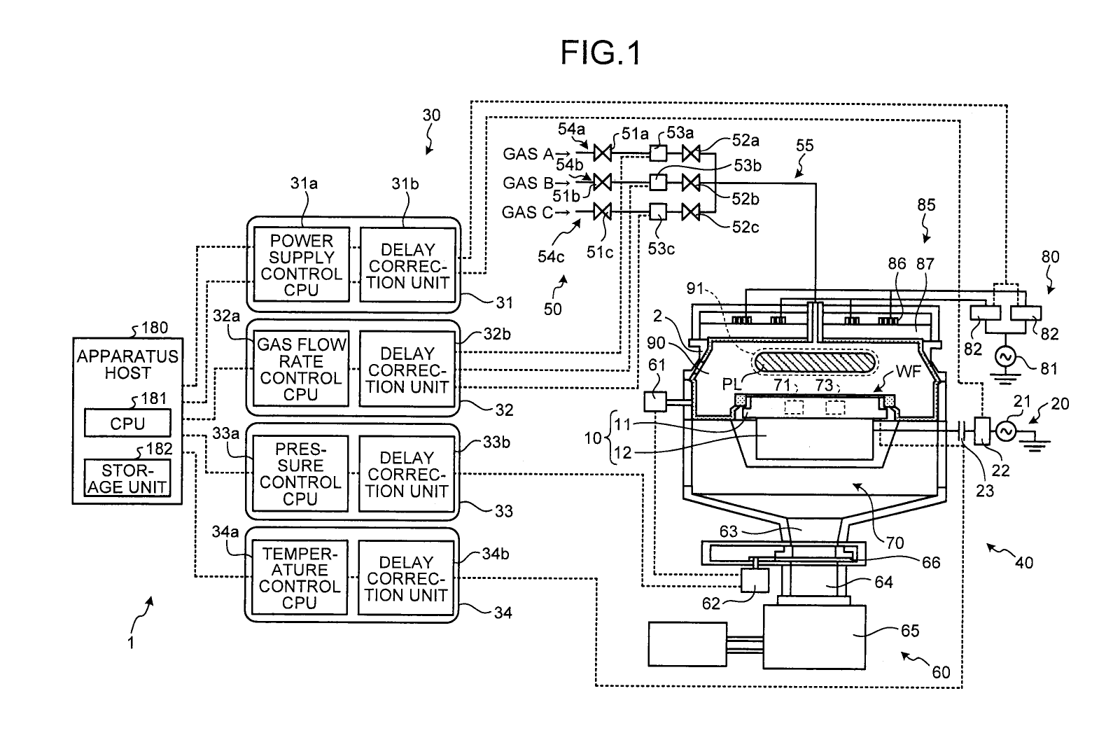

A substrate processing apparatus 1 according to a first embodiment will now be described with reference to FIG. 1. FIG. 1 is a diagram illustrating a schematic configuration of the substrate processing apparatus 1 according to the first embodiment.

The substrate processing apparatus 1 includes a substrate processing unit 40, a power supply 20 or 80, and a control unit 30. The substrate processing unit 40 includes a processing chamber 90, an electrode 10, a plasma generation unit 85, a gas flow rate adjustment unit 50, a pressure adjustment unit 60, and a temperature adjustment unit 70.

The processing chamber 90 is a chamber configured to generate plasma therein, and is formed of a processing chamber 2. The processing chamber 2 is configured to be capable of supplying processing gas from the gas flow rate adjustment unit 50 to the processing chamber 90 and configured to be capable of exhausting the processing gas finished in processing from the processing chamber 90 to the pressure adjustment unit 60.

The electrode 10 is disposed on a bottom face side in the processing chamber 90, to be insulated from the processing chamber 2 via an insulating member (not illustrated). A substrate to be processed WF such as a silicon wafer is placed on the electrode 10. The electrode 10 includes a stage 11 and an electrode unit 12. The stage 11 includes, for example, an electro static chuck (ESC) mechanism and holds the substrate to be processed WF by using the electro static chuck mechanism. The stage 11 is adjusted in temperature by the temperature adjustment unit 70 under control exercised by the control unit 30. As a result, the temperature adjustment unit 70 adjusts temperature of the substrate to be processed WF via the stage 11. The electrode unit 12 is supplied with power from the power supply 20, and the electrode unit 12 supplies power to the substrate to be processed WF via the stage 11. Each of the stage 11 and the electrode unit 12 is formed of metal such as, for example, stainless steel or aluminum.

The power supply 80 is a power supply that supplies power to process the substrate to be processed WF. The power supply 80 supplies radio frequency power to the plasma generation unit 85. The power supply 80 includes a radio frequency power supply 81 and matching boxes 82.

The plasma generation unit 85 generates plasma PL in a space 91 separated from the electrode 10 in the processing chamber 90 using the power supplied by the power supply 80. Specifically, the plasma generation unit 85 includes an antenna coil 86 and a dielectric wall 87. The radio frequency power supply (RF power supply) 81 generates radio frequency power and supplies the radio frequency power to the antenna coil 86. If impedance matching is attained between the radio frequency power supply 81 and the antenna coil 86 by the matching boxes 82, an electromagnetic wave is transmitted through the dielectric wall 87 which functions as a top wall of the processing chamber 2 as well and introduced into the space 91 in the processing chamber 90, under control of the control unit 30. In the space 91 in the processing chamber 90, the plasma PL is generated by ionization of the processing gas and ions (such as, for example, F⁺, CF₃⁺) are generated together with radicals from the processing gas.

The power supply 20 generates a bias voltage on the electrode 10 disposed on the bottom face side in the processing chamber 90. Specifically, the power supply 20 includes a radio frequency power supply (RF power supply) 21, a matching box 22, and a blocking capacitor 23. The radio frequency power supply 21 generates radio frequency power. If impedance matching is attained by the matching box 22, the bias voltage is applied to the electrode 10 via the blocking capacitor 23 under control of the control unit 30. If the bias voltage is applied, a potential difference from the plasma PL is generated, ions (such as, for example, F⁺, CF₃⁺) generated in a plasma PL area are drawn into the substrate to be processed WF, and anisotropic etching processing is conducted.

It should be noted that the substrate processing apparatus 1 may have a configuration in which the power supply 20 or 80 is omitted and the unit is connected to a ground potential.

The gas flow rate adjustment unit 50 adjusts a supply quantity of each processing gas to the processing chamber 90 (a flow rate of each processing gas supplied to the processing chamber 90). Specifically, the gas flow rate adjustment unit 50 includes a plurality of individual gas supply tubes 54a to 54c, a plurality of opening/closing valves 51a to 51c, a plurality of flow rate controllers (MFC: Mass Flow Controllers) 53a to 53c, a plurality of opening/closing valves 52a to 52c, and a gas supply tube 55 which supplies mixed gas. The plurality of individual gas supply tubes 54a, 54b and 54c are supplied with processing gas A, processing gas B and processing gas C from gas cylinders (not illustrated), respectively. Each of the plurality of opening/closing valves 51a to 51c is controlled by the control unit 30. When the opening/closing valve 51a is brought into an open state at predetermined timing, therefore, the processing gas A is supplied to the flow rate controller 53a. When the opening/closing valve 51b is brought into an open state at predetermined timing, the processing gas B is supplied to the flow rate controller 53b. When the opening/closing valve 51c is brought into an open state at predetermined timing, the processing gas C is supplied to the flow rate controller 53c. The plurality of flow rate controllers 53a to 53c are controlled by the control unit 30 to control flow rates of supplied processing gas A, processing gas B, and processing gas C, at predetermined timing and supply mixed gas to the processing chamber 90 via the gas supply tube 55.

The pressure adjustment unit 60 has an auto pressure controller (APC) function, and controls pressure in the processing chamber 90 by adjusting an exhaust quantity of the processing gas. Specifically, the pressure adjustment unit 60 includes a pressure sensor 61, an exhaust tube 63, a pressure controller 62, an exhaust tube 64, and a vacuum pump 65. The pressure sensor 61 detects the pressure in the processing chamber 90 and supplies information of a value of the pressure to the pressure controller 62. The pressure controller 62 is connected to the processing chamber 90 via the exhaust tube 63 and connected to the vacuum pump 65 via the exhaust tube 64. The pressure controller 62 includes an adjustment valve 66 and adjusts opening of the adjustment valve 66 to cause the pressure in the processing chamber 90 to become a target value according to the pressure value supplied from the pressure sensor 61 under control of the control unit 30. As a result, the control unit 30 controls the pressure in the processing chamber 90 by using the exhaust quantity of the processing gas.

The temperature adjustment unit 70 adjusts temperature of the substrate to be processed WF via the stage 11. Specifically, the temperature adjustment unit 70 includes a temperature sensor 71 and a temperature adjuster (heater or cooler) 73 disposed in the stage 11. The temperature sensor 71 detects temperature of the stage 11. The temperature sensor 71 supplies information of the detected temperature to the control unit 30. The control unit 30 controls the temperature adjuster 73 to cause the temperature of the stage 11 to become target temperature. As a result, the control unit 30 controls the temperature of the substrate to be processed WF via the stage 11.

The control unit 30 is connected to an apparatus host 180 to be capable of communicating with the apparatus host 180, and receives an instruction (for example, a changeover signal) from the apparatus host 180. The control unit 30 generally controls units in the substrate processing apparatus 1 in accordance with the received instruction (for example, the changeover signal). Specifically, the control unit 30 includes a power supply control unit 31, a gas flow rate control unit 32, a pressure control unit 33, and a temperature control unit 34. The power supply control unit 31 includes a power supply control CPU 31a. The power supply control CPU 31a controls the power supply 20 or 80 to cause power used to process the substrate to be processed WF to become a target value. The gas flow rate control unit 32 includes a gas flow rate control CPU 32a. The gas flow rate control CPU 32a controls the gas flow rate adjustment unit 50 to cause a supply quantity of processing gas of each kind to the processing chamber 90 to become a target value. The pressure control unit 33 includes a pressure control CPU 33a. The pressure control CPU 33a controls the pressure adjustment unit 60 to cause the pressure in the processing chamber 90 to become a target value. The temperature control unit 34 includes a temperature control CPU 34a. The temperature control CPU 34a controls the temperature adjustment unit 70 to cause the temperature of the stage 11 to become a target value.

The apparatus host 180 generally controls the power supply control unit 31, the gas flow rate control unit 32, the pressure control unit 33, and the temperature control unit 34 in the control unit 30. The apparatus host 180 includes a CPU 181 and a storage unit 182. The storage unit 182 stores recipe information. The recipe information includes information of the order of a processing condition and contents (the gas flow rate, pressure, temperature, power and the like) of each processing condition at the time when conducting continuous processing while changing over a plurality of processing conditions successively. The CPU 181 transmits instructions including target values to the power supply control unit 31, the gas flow rate control unit 32, the pressure control unit 33, and the temperature control unit 34 in the control unit 30, in accordance with each processing condition and a power supply level in the recipe information stored in the storage unit 182. As a result, batch processing on a multilayer film is conducted.

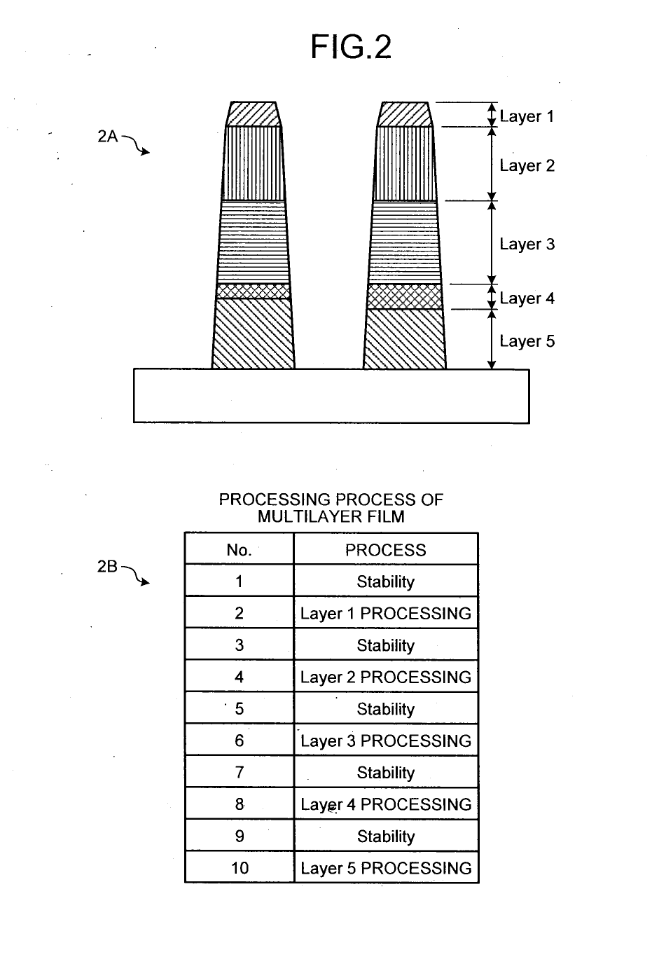

For example, in the batch processing on a multilayer film, a suitable processing condition such as the gas flow rate, pressure, temperature, and power is changed over successively every layer as illustrated in 2A and 2B in FIG. 2. In FIGS. 2, 2A and 2B are diagrams illustrating a procedure of the batch processing. For example, in process 2, process 4, process 6, process 8, and process 10 illustrated in 2B in FIG. 2, layer 1, layer 2, layer 3, layer 4, and layer 5 illustrated in 2A in FIG. 2 are subject to etching processing, respectively.

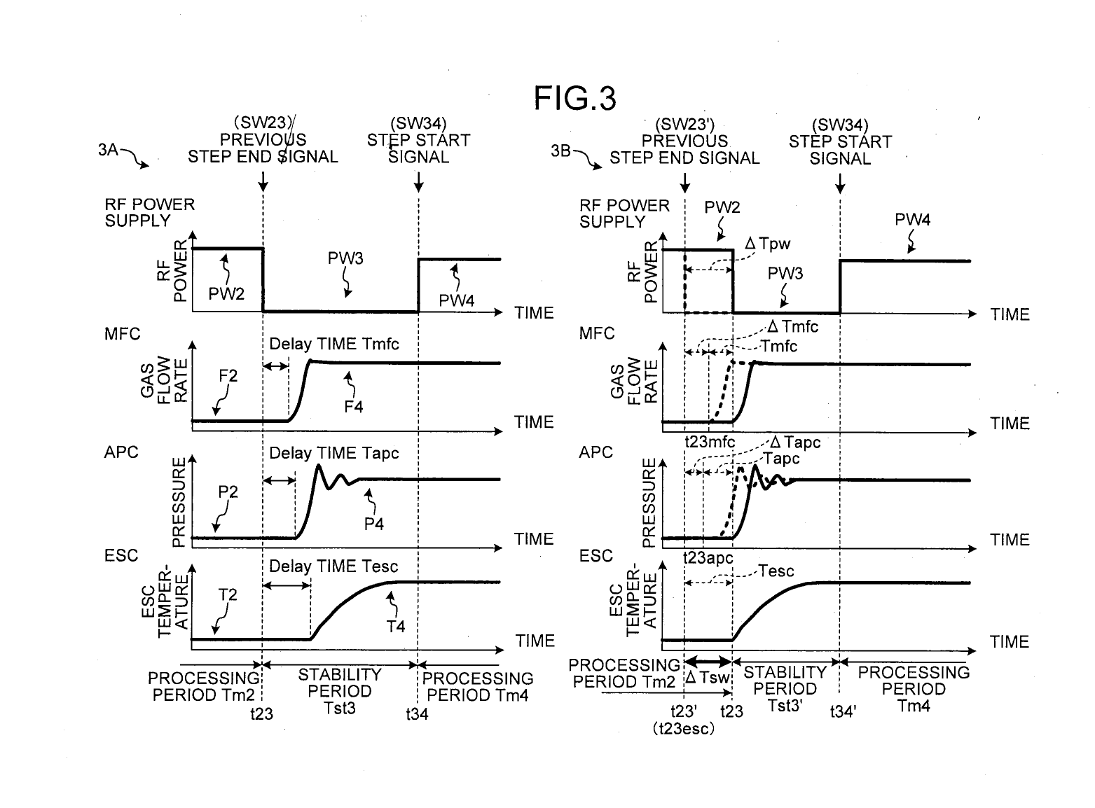

That is, the substrate processing unit 40 (the processing chamber 90, the electrode 10, the plasma generation unit 85, the gas flow rate adjustment unit 50, the pressure adjustment unit 60, and the temperature adjustment unit 70) can conduct processing on the substrate to be processed WF under a plurality of processing conditions (see 2B in FIG. 2) successively in accordance with control of the control unit 30. Each processing condition includes a plurality of kinds of processing parameters. The plurality of kinds of processing parameters included in each processing condition includes, for example, at least one of the flow rate of processing gas introduced into the processing chamber 90, the pressure in the processing chamber 90, and the temperature of the stage 11 besides the power supplied from the electrode 10 (see 3A in FIG. 3).

At this time, a stability period is provided before a processing period during which each layer is processed as illustrated in 2B in FIG. 2, to suspend plasma discharge and stabilize the processing condition. For example, as illustrated in 3A in FIG. 3, a stability period Tst3 is provided between a processing period Tm2 during which processing on the layer 1 is conducted and a processing period Tm4 during which processing on the layer 2 is conducted. As the number of layers to be processed increases in the batch processing of the multilayer film, a total length of stability periods in total processing time of the multiplayer film becomes long in time, and consequently the total processing time of the multilayer film tends to increase remarkably. If the total processing time of the multilayer film increases, productivity of a semiconductor device to be manufactured becomes lower, and consequently many apparatuses become necessary to improve the productivity and there is a possibility of increasing the cost.

This stability period was studied. As a result, it was found that the power supply control unit 31, the gas flow rate control unit 32, the pressure control unit 33, and the temperature control unit 34 in the control unit 30 operated as illustrated in 3A in FIG. 3, in a case where the processing period of processing in the immediately preceding step finished and the apparatus host 180 issued an instruction to conduct changeover to the next processing condition.

The power supply control unit 31 changes over power of the power supply 20 or 80 from a level PW2 to a level PW3 (≈0) in synchronism with an end signal (a changeover signal SW23) of previous step. The level PW2 is a level of power corresponding to a processing condition of the layer 1. The level PW3 is a level of power that does not generate plasma and that corresponds to the stability period Tst3 provided to stabilize a processing condition of the layer 2. And the power control unit 31 changes over the power of the power supply 20 or 80 from the level PW3 to a level PW4 in synchronism with a step start signal (a changeover signal SW34). The level PW4 is a power level corresponding to the processing condition of the layer 2. That is, the power supply control unit 31 can conduct changeover to the next processing condition rapidly in synchronism with the changeover signal.

It should be noted that each of the end signal of the previous step (the changeover signal SW23) and the step start signal (the changeover signal SW34) is transmitted from the apparatus host 180 to the control unit 30. Timing of each changeover signal illustrated in 3A in FIG. 3 indicates timing of transmission from the apparatus host 180 toward the control unit 30. If a transmission delay on a communication line between the apparatus host 180 and the control unit 30 can be neglected, timing of each changeover signal illustrated in 3A in FIG. 3 can also be regarded as timing of reception by the control unit 30. As illustrated in 3A in FIG. 3, timing of the end signal of the previous step (the changeover signal SW23) is timing determined as a start point of the stability period Tst3. Timing of the step start signal (the changeover signal SW34) is timing determined as an end point of the stability period Tst3. A length of the stability period Tst3 is determined considering the longest time among time values required since the changeover instruction (the changeover signal SW23) is transmitted from the apparatus host 180 until respective processing conditions (the gas flow rate, the pressure, and the temperature) become stable. In the case illustrated in 3A in FIG. 3, time required until the temperature becomes stable is the longest. As a result, the length of the stability period Tst3 is determined to become at least the time required until the temperature becomes stable.

On the other hand, the gas flow rate control unit 32 starts changeover of the flow rate of the processing gas from a flow rate F2 to a flow rate F4 after a delay time Tmfc has elapsed since timing t23 of the end signal of the previous step (the changeover signal SW23). The flow rate F2 is a flow rate corresponding to the processing condition of the layer 1. The flow rate F4 is a flow rate corresponding to the processing condition of the layer 2. The delay time Tmfc is generated by, for example, that the gas flow rate control unit 32 exchanges signals with the apparatus host 180 and the gas flow rate control unit 32 supplies control signals to the plurality of flow rate controllers 53a to 53c serially and successively. And the gas flow rate control unit 32 stabilizes the flow rate of the processing gas at the flow rate F4 until timing of the step start signal (the changeover signal SW34) and keeps the flow rate of the processing gas at the flow rate F4 after the step start signal (the changeover signal SW34).

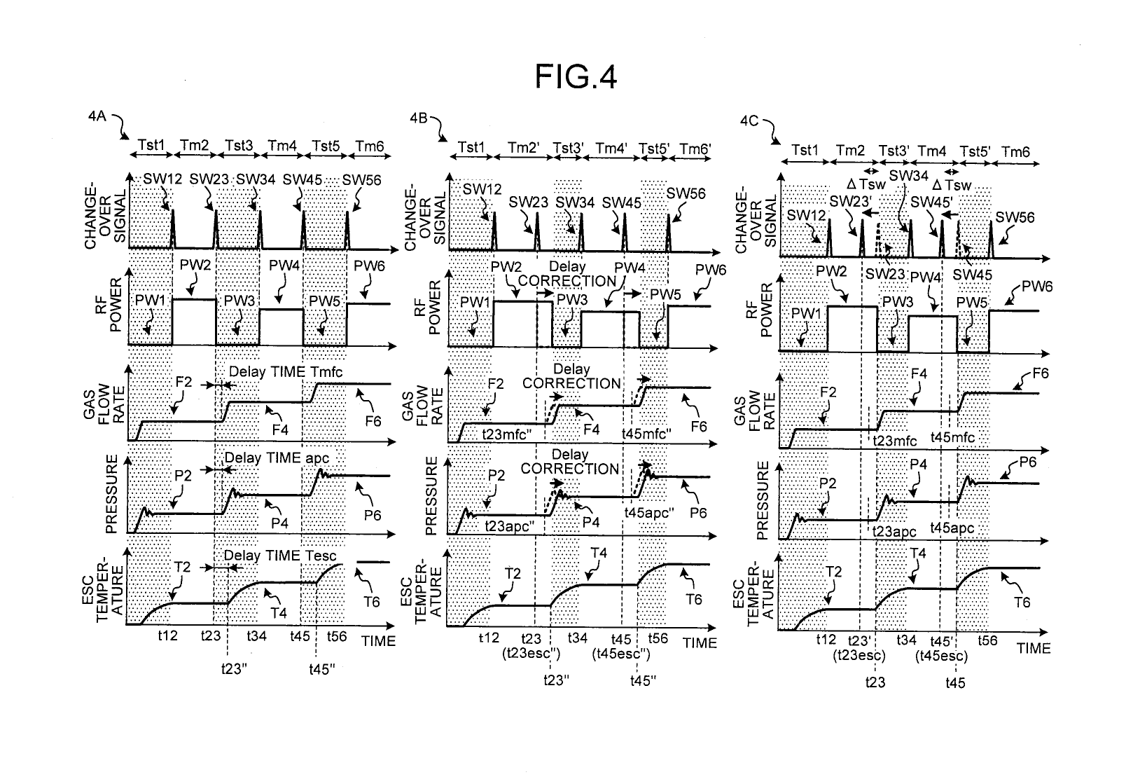

That is, the gas flow rate control unit 32 starts changeover to the next processing condition with respect to each of the plurality of kinds of processing gas after a delay of the delay time Tmfc from a changeover signal (see 4A in FIG. 4). In other words, during the delay time Tmfc after the gas flow rate control unit 32 conducts an operation of receiving the end signal of the previous step (the changeover signal SW23) transmitted by the apparatus host 180, the gas flow rate control unit 32 conducts a preparation operation of changeover to the next processing condition. This preparation operation is an operation conducted as preparation to change over the gas flow rate included in other processing parameters different from the power, from a level corresponding to the current processing condition to a level corresponding to the next processing condition. The preparation operation for changeover to the next processing condition includes, for example, a conversion operation conducted to convert a signal form of the received end signal of the previous step (the changeover signal SW23) to a signal form that can be recognized by the gas flow rate control unit 32, a transmission operation conducted to serially transmit control signals from the gas flow rate control unit 32 to the plurality of flow rate controllers 53a to 53c, and a mechanical drive operation conducted to adjust opening of the valves in the flow rate controllers 53a to 53c in accordance with the end signal of the previous step (the changeover signal SW23). In the preparation operation conducted to change over to the next processing condition, time for the transmission operation and the mechanical drive operation is considered to be longer than time for the conversion operation.

It should be noted, in FIG. 3 and FIG. 4, the processing condition is exemplified as to one kind of processing gas among the plurality of kinds of processing gas. However, the gas flow rate control unit 32 exercises similar control on other kinds of processing gas as well.

The pressure control unit 33 starts changeover of the pressure in the processing chamber 90 from pressure P2 to pressure P4 after a delay time Tapc has elapsed since the timing t23 of the end signal of the previous step (the changeover signal SW23). The pressure P2 is pressure in the processing chamber 90 corresponding to the processing condition of the layer 1. The pressure P4 is pressure in the processing chamber 90 corresponding to the processing condition of the layer 2. The delay time Tapc is generated by, for example, that the pressure control unit 33 exchanges signals with the apparatus host 180 and a mechanical operation of the adjustment valve 66 in the pressure adjustment unit 60 and the like. And the pressure control unit 33 stabilizes the pressure in the processing chamber 90 at the pressure P4 until timing of the step start signal (the changeover signal SW34) and keeps the pressure in the processing chamber 90 at the pressure P4 after the step start signal (the changeover signal SW34).

That is, the pressure control unit 33 starts changeover to the next processing condition after a delay of the delay time Tapc from a changeover signal (see 4A in FIG. 4). In other words, during the delay time Tapc after the pressure control unit 33 conducts an operation of receiving the end signal of the previous step (the changeover signal SW23) transmitted by the apparatus host 180, the pressure control unit 33 conducts a preparation operation of changeover to the next processing condition. This preparation operation is an operation conducted as preparation to change over the pressure included in other processing parameters different from the power, from a level corresponding to the current processing condition to a level corresponding to the next processing condition. The preparation operation for changeover to the next processing condition includes, for example, a conversion operation conducted to convert a signal form of the received end signal of the previous step (the changeover signal SW23) to a signal form that can be recognized by the pressure control unit 33, and a mechanical drive operation conducted to adjust opening of the adjustment valve 66 in accordance with the end signal of the previous step (the changeover signal SW23). In the preparation operation conducted to change over to the next processing condition, time for the mechanical drive operation is considered to be longer than time for the conversion operation.

The temperature control unit 34 starts changeover of the temperature of the stage 11 from temperature T2 to temperature T4 after a delay time Tesc has elapsed since the timing t23 of the end signal of the previous step (the changeover signal SW23). The temperature T2 is temperature of the stage 11 corresponding to the processing condition of the layer 1. The temperature T4 is temperature of the stage 11 corresponding to the processing condition of the layer 2. The delay time Tesc is generated by, for example, that the temperature control unit 34 exchanges signals with the apparatus host 180, and thermal conduction time at the time when the stage 11 is heated or cooled, and the like. And the temperature control unit 34 stabilizes the temperature of the stage 11 at the temperature T4 until timing of the step start signal (the changeover signal SW34) and keeps the temperature of the stage 11 at the temperature T4 after the step start signal (the changeover signal SW34).

That is, the temperature control unit 34 starts changeover to the next processing condition after a delay of the delay time Tesc from a changeover signal (see 4A in FIG. 4). In other words, during the delay time Tesc after the apparatus host 180 transmits the end signal of the previous step (the changeover signal SW23), the temperature control unit 34 conducts a preparation operation of changeover to the next processing condition. This preparation operation is an operation conducted as preparation to change over the temperature included in other processing parameters different from the power, from a level corresponding to the current processing condition to a level corresponding to the next processing condition. The preparation operation for changeover to the next processing condition includes, for example, a conversion operation conducted to receive the end signal of the previous step (the changeover signal SW23) and convert a signal form of the received end signal to a signal form that can be recognized by the temperature control unit 34, and a heat transfer operation conducted to cause temperature adjuster (heater or cooler) 73 to operate and transfer heat to the stage 11 in accordance with the end signal of the previous step (the changeover signal SW23). In the preparation operation conducted to change over to the next processing condition, time for the heat transfer operation is considered to be longer than time for the conversion operation.

In this way, it has been found that there is time during which changeover is not actually conducted (time for the preparation operation) and consequently there is room to be shortened.

The first embodiment indicates a method to shorten the stability period by exercising control in the substrate processing apparatus 1 to start the preparation operation for changeover to the next processing condition before processing in the previous step finishes.

Specifically, the control unit 30 exercises control to start preparation operation for changeover to a second processing condition in the substrate processing unit 40 before timing of changeover of the power supply 20 or 80 from the level PW2 corresponding to a first processing condition to the level PW3. For example, the gas flow rate control unit 32, the pressure control unit 33, and the temperature control unit 34 in the control unit 30 starts a response to a changeover signal (for example, a conversion operation of a changeover signal received from the apparatus host 180) before timing of the power supply 20 or 80 from the level PW2 to the level PW3.

That is, in a case where delay time of power≈0, the apparatus host 180 hastens timing of transmitting the changeover signal to the control unit 30 considering the longest time among delay time Tmfc, Tapc and Tesc of each processing condition (gas flow rate, pressure, temperature, and power). For example, in a case where the delay time Tesc is the longest among the delay time Tmfc, Tapc and Tesc as illustrated in 3A in FIG. 3, the apparatus host 180 hastens the changeover signal transmitted to the control unit 30 by the delay time Tesc.

Here, the changeover signal of the gas flow rate, pressure, power and temperature is triggered by the previous step end signal (SW23), and consequently the changeover signal becomes a signal (SW23′) hastened by the delay time Tesc. If only the changeover signal of the gas flow rate, pressure, power and temperature is hastened, malfunction occurs. Therefore, the delay time in each unit is adjusted to synchronize rise timing of the gas flow rate, pressure, and temperature with timing of falling of power (PW2→PW3).

In the case of the power supply, delay time of power≈0, and consequently the power supply control unit 31 changes over the level of the power from PW2 to PW3 at timing t23′ which precedes the timing t23 when the level of power should originally be changed over as indicated by a dashed line in 3B in FIG. 3. As a result, plasma in the processing chamber 90 disappears although the processing on the substrate to be processed WF is not completed yet, resulting in malfunction in a processed shape. Therefore, timing of changeover of the level of power from the PW2 to the PW3 is adjusted to synchronize with timing of rising of each parameter (for example, the stage temperature) in the processing condition by causing a power supply delay correction unit (31b) to delay the timing of changeover of the power level from the PW2 to the PW3 by ΔTpw (=ΔTsw). That is, the power supply delay correction unit (31b) finds correction time that satisfies the following expression and delays a response to the changeover signal with the found correction time.

(Correction time which delays the response to the changeover signal)+(delay time from response start to changeover start)≧(time from the timing t23′ to the timing t23)

In the case of the power supply, (delay time from response start to changeover start)≈0 and consequently the following expression is satisfied.

(Correction time which delays the response to the changeover signal)≧(time from the timing t23′ to the timing t23)

In the case of the gas flow rate, the delay time Tmfc<the delay time Tesc. If the gas flow rate is changed over at timing of SW23′, therefore, the gas flow rate control unit 32 starts changeover of the gas flow rate at timing before the timing t23 when the power supply and the temperature are changed over as indicated by a dashed line in 3B in FIG. 3. As a result, the flow rate of the processing gas in the processing period Tm2 deviates from the suitable flow rate F2, and there is a possibility that malfunction will occur in the processing shape of the substrate to be processed WF. Therefore, timing of changeover of the level of gas flow rate from the F2 to the F4 is adjusted to synchronize with changeover timing of each parameter (for example, the stage temperature) in the power supply and the processing condition by causing an MFC delay correction unit (32b) to delay the changeover timing of the gas flow rate level from the F2 to the F4 by ΔTmfc (=ΔTsw−Tmfc). That is, the MFC delay correction unit (32b) finds correction time that satisfies the following expression and delays a response to the changeover signal with the found correction time.

(Correction time which delays the response to the changeover signal)+(delay time from response start to changeover start)≧(time from the timing t23′ to the timing t23)

In the case of the pressure, the delay time Tapc<the delay time Tesc. If the pressure is changed over at timing of SW23′, therefore, the pressure control unit 33 starts changeover of the pressure at timing before the timing t23 when the power supply, the gas flow rate, and the temperature are changed over as indicated by a dashed line in 3B in FIG. 3. As a result, the pressure in the processing chamber 90 in the processing period Tm2 deviates from the suitable pressure P2, and there is a possibility that malfunction will occur in the processing shape of the substrate to be processed WF. Therefore, timing of changeover of the pressure level from the P2 to the P4 is adjusted to synchronize with changeover timing of each parameter (for example, the gas flow rate and the stage temperature) in the power supply and the processing condition by causing an APC delay correction unit (33b) to delay the changeover timing of the pressure level from the P2 to the P4 by ΔTapc (=ΔTsw−Tapc). That is, the APC delay correction unit (33b) finds correction time that satisfies the following expression and delays a response to the changeover signal with the found correction time.

(Correction time which delays the response to the changeover signal)+(delay time from response start to changeover start)≧(time from the timing t23′ to the timing t23)

It should be noted that, in a case where an ESC delay correction unit (34b) delays timing of changeover of the stage temperature from the T2 to the T4 later than t23, the timing may be delayed by the ΔTapc (=ΔTsw−Tapc). In a case where the timing of changeover of the stage temperature from the T2 to the T4 is adjusted to synchronize with the changeover timing of the power supply, the gas flow rate, and the pressure, however, it is not necessary to delay the timing of changeover of the stage temperature. That is, the ESC delay correction unit (34b) may find correction time that satisfies the following expression and delay a response to the changeover signal with the found correction time. In the case where the timing of changeover of the stage temperature from the T2 to the T4 is synchronized with the changeover timing of the power supply, the gas flow rate, and the pressure, however, the correction time may be set equal to 0.

(Correction time which delays the response to the changeover signal)+(delay time from response start to changeover start)≧(time from the timing t23′ to the timing t23)

In the case where the changeover timing of the stage temperature is synchronized with the changeover timing of the power supply, the gas flow rate, and the pressure, it is permissible that (correction time which delays the response to the changeover signal)=0 and consequently the following expression is satisfied.

(Delay time from response start to changeover start)≧(time from the timing t23′ to the timing t23)

In this way, the timing of the changeover signal is hastened considering the longest time among the delay time values Tmfc, Tapc, and Tesc (delay time of the power≈0) of respective processing conditions (the gas flow rate, the pressure, the temperature, and the power). In other units (in the case of FIG. 3, the power supply, MFC, and APC), therefore, each delay unit needs to correct the response timing to synchronize the changeover timing. When the delay unit conducts correction, it is necessary to make the correction time that delays the response to the changeover signal longer for a unit having a shorter delay time.

Hereafter, a detailed correction method will be described. For example, the control unit 30 corrects the operation illustrated in 3A in FIG. 3 to the operation illustrated in 3B in FIG. 3 and exercises control. Or for example, the control unit 30 corrects an operation illustrated in 4A in FIG. 4 to an operation illustrated in 4C in FIG. 4 and exercises control. Each of 3A in FIGS. 3 and 4A in FIG. 4 is a diagram illustrating an operation of each of the power supply control unit 31, the gas flow rate control unit 32, the pressure control unit 33, and the temperature control unit 34 before correction is conducted on the delay time. Each of 3B in FIGS. 3 and 4C in FIG. 4 is a diagram illustrating an operation of each of the power supply control unit 31, the gas flow rate control unit 32, the pressure control unit 33, and the temperature control unit 34 after correction is conducted on the delay time. In FIG. 4, 4B is a diagram illustrating an operation of each of the power supply control unit 31, the gas flow rate control unit 32, the pressure control unit 33, and the temperature control unit 34 in an intermediate stage of the correction of the delay time.

More specifically, the gas flow rate control unit 32 exercises control to start preparation operation for changeover from the flow rate F2 to the flow rate F4 conducted by the gas flow rate adjustment unit 50, before the timing t23 when the power supply 20 or 80 changes over from the level PW2 to the level PW3 (≈0). The pressure control unit 33 exercises control to start preparation operation for changeover from the pressure P2 to the pressure P4 conducted by the pressure adjustment unit 60, before the timing t23 when the power supply 20 or 80 changes over from the level PW2 to the level PW3≈0). The temperature control unit 34 exercises control to start preparation operation for changeover from the temperature T2 to the temperature T4 before the timing t23 when the power supply 20 or 80 changes over from the level PW2 to the level PW3≈0).

Furthermore, the control unit 30 adjusts timing of each unit to cause timing of changeover to the second processing condition is actually started with respect to the gas flow rate, the pressure, and the temperature (timing of rising or falling of the waveform illustrated in 3B in FIG. 3) to become later than timing of changeover of the power supply 20 or 80 from the level PW2 to the level PW3. For example, the control unit 30 corrects the operation illustrated in 3A in FIG. 3 to the operation illustrated in 3B in FIG. 3.

More specifically, the control unit 30 shifts the timing of the previous step end signal from t23 to the timing t23′ preceding by the time ΔTsw as illustrated in 3B in FIG. 3. The time ΔTsw is substantially the same time as the largest delay time among delay time values of respective processing conditions (for example, in the case of 3A in FIG. 3, the delay time Tesc of the temperature of the stage 11).

The control unit 30 includes the delay correction units 31b to 34b to adjust timing in respective units. The power supply control unit 31 further includes the delay correction unit 31b. The delay correction unit 31b controls the power supply 20 or 80 to cause timing of changeover from the level PW2 to the level PW3 is conducted to become t23 illustrated in 3B in FIG. 3. The delay correction unit 31b conducts correction to cause timing of changeover from the level PW2 to the level PW3 to become the timing t23 obtained by delaying the timing t23′ of the previous step end signal SW23′ by the correction time ΔTpw. This correction corresponds to shifting a falling portion indicated by a dashed line in the power supply waveform illustrated in 3B in FIGS. 3 and 4B in FIG. 4 to a falling portion indicated by a solid line. The correction time ΔTpw satisfies the following Expression 1.

ΔTpw≈ΔTsw Expression 1

It should be noted that, in a case where the delay time in each step can be regarded as constant, correction time ΔTpw acquired experimentally beforehand may be set in the delay correction unit 31b. For example, the delay correction unit 31b may correct timing of conducting changeover from the level PW4 to a level PW5 to timing obtained by delaying timing t45′ of a changeover signal SW45′ by the correction time ΔTpw as illustrated in FIG. 4.

For example, the power supply control unit 31 starts a count operation in a timer (not illustrated) at timing of reception of the changeover signal from the apparatus host 180, and retains the changeover signal in a buffer memory (not illustrated) without immediately giving a response to the changeover signal. And the power supply control unit 31 starts a response (for example, a conversion operation) to the changeover signal at timing of count time in the timer becoming at least the correction time ΔTpw. As a result, the power supply control unit 31 can change over the power level at the suitable timing t23 at which the power level should be changed over.

The gas flow rate control unit 32 further includes the delay correction unit 32b. The delay correction unit 32b adjusts timing t23mfc to cause timing of start of changeover from the flow rate F2 to the flow rate F4 conducted by the gas flow rate adjustment unit 50 to become the timing t23 of changeover of the power supply 20 or 80 from the level PW2 to the level PW3 or later (for example, substantially the same time as the timing t23). For example, the timing t23mfc is timing of starting the preparation operation for changeover from the flow rate F2 to the flow rate F4 conducted by the gas flow rate adjustment unit 50 (that is, a response to the changeover signal). The delay correction unit 32b corrects the timing t23mfc of starting preparation operation for changeover from the flow rate F2 to the flow rate F4 (that is, a response to the changeover signal) to timing obtained by delaying the timing t23′ of the previous step end signal SW23′ by a correction time ΔTmfc. This correction corresponds to shifting a rising portion of a waveform of the gas flow rate indicated by a dashed line in 3B in FIGS. 3 and 4B in FIG. 4 to a rising portion indicated by a solid line. For example, in a case where correction is conducted to cause the actual changeover to become concurrent with the timing t23, the correction time ΔTmfc satisfies the following Expression 2.

ΔTmfc≈ΔTsw−Tmfc Expression 2

In Expression 2, Tmfc is a delay time at the time when adjusting the flow rate of the processing gas.

It should be noted that, in a case where the delay time in each step can be regarded as constant, correction time ΔTmfc experimentally acquired beforehand may be set in the delay correction unit 32b. For example, the delay correction unit 32b may correct timing of changeover from the flow rate F4 to a flow rate F6 to timing obtained by delaying the timing t45′ of the changeover signal SW45′ in 4C in FIG. 4 by the correction time ΔTmfc.

For example, the gas flow rate control unit 32 starts a count operation in a timer (not illustrated) at timing of receiving a changeover signal from the apparatus host 180, and retains the changeover signal in a buffer memory (not illustrated) without immediately giving a response to the changeover signal. And the gas flow rate control unit 32 starts a response (for example, a conversion operation) to the changeover signal at timing of a count time in the timer becoming at least the correction time ΔTmfc. As a result, the gas flow rate control unit 32 can cause changeover of the flow rate to be started at the timing t23 of permitting changeover of the flow rate or later (for example, at the same time as the timing t23).

The pressure control unit 33 further includes the delay correction unit 33b. The delay correction unit 33b adjusts timing t23apc to cause timing of start of changeover from the pressure P2 to the pressure P4 conducted by the pressure adjustment unit 60 to become the timing t23 of changeover of the power supply 20 or 80 from the level PW2 to the level PW3 or later (for example, the same time as the timing t23). The timing t23apc is timing of starting the preparation operation for changeover from the pressure P2 to the pressure P4 conducted by the pressure adjustment unit 60 (that is, a response to the changeover signal). The delay correction unit 33b corrects the timing t23apc of starting preparation operation for changeover from the pressure P2 to the pressure P4 to timing obtained by delaying the timing t23′ of the previous step end signal SW23′ by a correction time ΔTapc. This correction corresponds to shifting a rising portion of a waveform of the pressure indicated by a dashed line in 3B in FIGS. 3 and 4B in FIG. 4 to a rising portion indicated by a solid line. For example, in a case where correction is conducted to cause the actual changeover to become concurrent with the timing t23, the correction time ΔTapc satisfies the following Expression 3.

ΔTapc≈ΔTsw−Tapc Expression 3

In Expression 3, Tapc is a delay time at the time when adjusting the pressure in the processing chamber 90.

It should be noted that, in a case where the delay time in each step can be regarded as constant, correction time ΔTapc experimentally acquired beforehand may be set in the delay correction unit 33b. For example, the delay correction unit 33b may correct timing of changeover from the pressure P4 to pressure P6 to timing obtained by delaying the timing t45′ of the changeover signal SW45′ in FIG. 4 by the correction time ΔTapc.

For example, the pressure control unit 33 starts a count operation in a timer (not illustrated) at timing of receiving a changeover signal from the apparatus host 180, and retains the changeover signal in a buffer memory (not illustrated) without immediately giving a response to the changeover signal. And the power supply control unit 31 starts a response (for example, a conversion operation) to the changeover signal at timing of a count time in the timer becoming at least the correction time ΔTapc. As a result, the pressure control unit 33 can cause changeover of the pressure to be started at the timing t23 of permitting changeover of the pressure or later (for example, at the same time as the timing t23).

The temperature control unit 34 further includes the delay correction unit 34b. The delay correction unit 34b adjusts timing t23esc to cause timing of start of changeover from the temperature T2 to the temperature T4 conducted by the temperature adjustment unit 70 to become the timing t23 of changeover of the power supply 20 or 80 from the level PW2 to the level PW3 or later (for example, the same time as the timing t23). The timing t23esc is timing of starting the preparation operation for changeover from the temperature T2 to the temperature T4 conducted by the temperature adjustment unit 70 (that is, a response to the changeover signal). The delay correction unit 34b corrects the timing t23esc of starting preparation operation for changeover from the temperature T2 to the temperature T4 to timing obtained by delaying the timing t23′ of the previous step end signal SW23′ by a correction time ΔTesc. This correction corresponds to not shifting a rising portion of a waveform of the temperature illustrated in 3B in FIGS. 3 and 4B in FIG. 4. For example, in a case where correction is conducted to cause the actual changeover to become concurrent with the timing t23, the correction time ΔTesc satisfies the following Expression 4.

ΔTesc≈ΔTsw−Tesc=0 Expression 4

In Expression 4, Tesc is a delay time at the time when adjusting the temperature of the stage 11. In the case of Expression 4, the correction time ΔTesc≈0. Therefore, the temperature control unit 34 starts preparation operation for changeover from the temperature T2 to the temperature T4 (that is, a response to the changeover signal) in synchronism with the changeover signal SW23′.

It should be noted that, in a case where the delay time in each step can be regarded as constant, correction time ΔTesc experimentally acquired beforehand may be set in the delay correction unit 34b. For example, the delay correction unit 34b may correct timing of changeover from the temperature T4 to temperature T6 to timing obtained by delaying the timing t45′ of the changeover signal SW45′ in FIG. 4 by the correction time ΔTesc. In the case of Expression 4, the correction time ΔTesc≈0. Therefore, the temperature control unit 34 starts preparation operation for changeover from the temperature T4 to the temperature T6 (that is, a response to the changeover signal) in synchronism with the changeover signal SW45′.

For example, the temperature control unit 34 starts a response to a changeover signal (for example, a conversion operation) at timing of receiving the changeover signal from the apparatus host 180. As a result, the temperature control unit 34 can cause changeover of temperature to be started at timing t23 of permitting changeover of temperature or later (for example, at the same time as the timing t23).

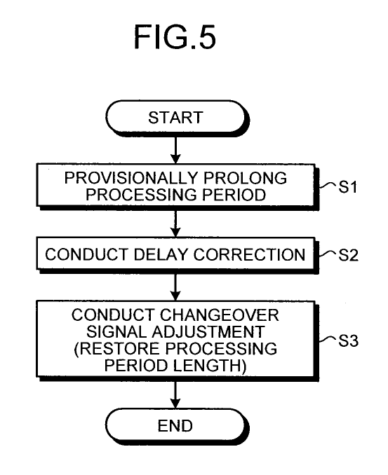

A concrete correction operation of the substrate processing apparatus 1 will now be described with reference to FIG. 4 and FIG. 5. FIG. 5 is a flow chart illustrating an operation of the substrate processing apparatus 1.

At step S1 illustrated in FIG. 5, the control unit 30 provisionally prolongs a processing period. The control unit 30 identifies greatest delay time among delay time values in respective processing conditions, and provisionally prolongs the processing period to cause timing of end of the processing period to coincide with timing of end of the identified delay time.

For example, in the case illustrated in 4A and 4B in FIG. 4, the delay time Tesc of the temperature of the stage 11 is larger than the delay time Tmfc of the gas flow rate and the delay time Tapc of the pressure. In this case, the control unit 30 provisionally prolongs the processing period to cause timing of end of the processing period to coincide with timing of end of the delay time Tesc in changeover of temperature. That is, the control unit 30 shifts timing of end of the processing period to timing obtained by delaying the original timing by the delay time Tesc while keeping a total length of the processing period and the stability period following the processing period constant. As a result, the stability period is shortened by the delay time Tesc.

For example, the control unit 30 provisionally prolongs a processing period Tm2′ to cause timing of end of the processing period Tm2′ to coincide with timing t23″ of end of the delay time Tesc in the changeover from the temperature T2 to the temperature T4. That is, the control unit 30 shifts timing of end of the processing period Tm2′ from the timing t23 to the timing t23″ obtained by delaying the timing t23 by the delay time Tesc while satisfying the following Expression 5. As a result, a stability period Tst3′ is shortened by the delay time Tesc as compared with the stability period Tst3.

(Length of the processing period Tm2′)+(length of the stability period Tst3′)

=(length of the processing period Tm2)+(length of the stability period Tst3) Expression 5

For example, the control unit 30 provisionally prolongs a processing period Tm4′ to cause timing of end of the processing period Tm4′ to coincide with timing t45″ of end of the delay time Tesc in the changeover from the temperature T4 to the temperature T6. That is, the control unit 30 shifts timing of end of the processing period Tm4′ from the timing t45 to timing t45″ obtained by delaying timing t45 by the delay time Tesc while satisfying the following Expression 6. As a result, a stability period Tst5′ is shortened by the delay time Tesc as compared with the stability period Tst5.

(Length of the processing period Tm4′)+(length of the stability period Tst5′)

=(length of the processing period Tm4)+(length of the stability period Tst5) Expression 6

At step S2 illustrated in FIG. 5, the control unit 30 conducts delay correction according to the processing period provisionally prolonged.

For example, in the case illustrated in 4B in FIG. 4, the control unit 30 conducts correction to cause timing of changeover of the power supply to coincide with timing of end of the processing period provisionally prolonged. The control unit 30 conducts correction to cause start timing of changeover of the pressure to coincide with timing of end of the processing period provisionally prolonged.

For example, the control unit 30 conducts correction to cause the timing of changeover of the power supply 20 or 80 from the level PW2 to the level PW3 to coincide with the timing t23″ of end of the processing period Tm2′ provisionally prolonged. That is, the control unit 30 corrects timing of changeover of the power supply 20 or 80 from the level PW2 to the level PW3 to the timing t23″ obtained by delaying the timing t23 by the correction time ΔTpw. This correction corresponds to shifting the falling portion of the waveform of the power supply indicated by the dashed line in 4B in FIG. 4 to the falling portion indicated by the solid line.

For example, the control unit 30 conducts correction to cause the timing of starting changeover of the flow rate of the processing gas from the flow rate F2 to the flow rate F4 to coincide with the timing t23″ of end of the processing period Tm2′ provisionally prolonged. That is, the control unit 30 corrects timing of starting a preparation operation for changeover of the flow rate of the processing gas from the flow rate F2 to the flow rate F4 (that is, a response to the changeover signal conducted by the gas flow rate control unit 32) to timing t23mfc″ obtained by delaying the timing t23 by the correction time ΔTmfc. This correction corresponds to shifting the rising portion of the waveform of the gas flow rate indicated by the dashed line in 4B in FIG. 4 to the rising portion indicated by the solid line.

For example, the control unit 30 conducts correction to cause the timing of starting changeover of the pressure in the processing chamber 90 from the pressure P2 to the pressure P4 to coincide with the timing t23″ of end of the processing period Tm2′ provisionally prolonged. That is, the control unit 30 corrects timing of starting a preparation operation for changeover of the pressure in the processing chamber 90 from the pressure P2 to the pressure P4 (that is, a response to the changeover signal conducted by the pressure control unit 33) to timing t23apc″ obtained by delaying the timing t23 by the correction time ΔTapc. This correction corresponds to shifting the rising portion of the waveform of the pressure indicated by the dashed line in 4B in FIG. 4 to the rising portion indicated by the solid line.

For example, the control unit 30 conducts correction to cause the timing of starting changeover of the temperature of the stage 11 from the temperature T2 to the temperature T4 to coincide with the timing t23″ of end of the processing period Tm2′ provisionally prolonged. That is, the control unit 30 corrects timing of starting a preparation operation for changeover of the temperature of the stage 11 from the temperature T2 to the temperature T4 (that is, a response to the changeover signal conducted by the temperature control unit 34) to timing t23esc″ obtained by delaying the timing t23 by the correction time ΔTesc (≈0). This correction corresponds to not shifting the rising portion of the waveform of the temperature illustrated in 4B in FIG. 4.

For example, the control unit 30 conducts correction to cause the timing of changeover of the power supply 20 or 80 from the level PW4 to the level PW5 to coincide with the timing t45″ of end of the processing period Tm4′ provisionally prolonged. That is, the control unit 30 corrects timing of changeover of the power supply 20 or 80 from the level PW4 to the level PW5 to the timing t45″ obtained by delaying the timing t45 by the correction time ΔTpw. This correction corresponds to shifting the falling portion of the waveform of the power supply indicated by the dashed line in 4B in FIG. 4 to the falling portion indicated by the solid line.

For example, the control unit 30 conducts correction to cause the timing of starting changeover of the flow rate of the processing gas from the flow rate F4 to the flow rate F6 to coincide with the timing t45″ of end of the processing period Tm4′ provisionally prolonged. That is, the control unit 30 corrects timing of starting a preparation operation for changeover of the flow rate of the processing gas from the flow rate F4 to the flow rate F6 (that is, a response to the changeover signal conducted by the gas flow rate control unit 32) to timing t45mfc″ obtained by delaying the timing t45 by the correction time ΔTmfc. This correction corresponds to shifting the rising portion of the waveform of the gas flow rate indicated by the dashed line in 4B in FIG. 4 to the rising portion indicated by the solid line.

For example, the control unit 30 conducts correction to cause the timing of starting changeover of the pressure in the processing chamber 90 from the pressure P4 to the pressure P6 to coincide with the timing t45″ of end of the processing period Tm4′ provisionally prolonged. That is, the control unit 30 corrects timing of starting a preparation operation for changeover of the pressure in the processing chamber 90 from the pressure P4 to the pressure P6 (that is, a response to the changeover signal conducted by the pressure control unit 33) to timing t45apc″ obtained by delaying the timing t45 by the correction time ΔTapc. This correction corresponds to shifting the rising portion of the waveform of the pressure indicated by the dashed line in 4B in FIG. 4 to the rising portion indicated by the solid line.

For example, the control unit 30 conducts correction to cause the timing of starting changeover of the temperature of the stage 11 from the temperature T4 to the temperature T6 to coincide with the timing t45″ of end of the processing period Tm4′ provisionally prolonged. That is, the control unit 30 corrects timing of starting a preparation operation for changeover of the temperature of the stage 11 from the temperature T4 to the temperature T6 (that is, a response to the changeover signal conducted by the temperature control unit 34) to timing t45esc″ obtained by delaying the timing t45 by the correction time ΔTesc (≈0). This correction corresponds to not shifting the rising portion of the waveform of the temperature illustrated in 4B in FIG. 4.

At step S3 illustrated in FIG. 5, the control unit 30 restores the length of the processing period in the processing step to the original length, and adjusts the timing of the changeover signal. In each of waveforms of the power supply and the processing conditions, the control unit 30 restores the length of the processing period in the processing step to the original length to shift a portion from the timing of the changeover signal to the timing of end of the processing period to the side of timing of start of the processing period. At this time, the control unit 30 shifts the changeover signal as well in similar way.

For example, in each waveform of the changeover signal, the power supply, the gas flow rate, the pressure, and the temperature in the case illustrated in 4B and 4C in FIG. 4, the control unit 30 shifts a portion from the timing of the changeover signal in a processing period of a processing step to the timing of end of the processing period of the processing step to the side of timing of start of the processing period, and restores the length of the processing period in the processing step to the original length.

For example, in each waveform of the changeover signal, the power supply, the gas flow rate, the pressure, and the temperature as illustrated in 4B in FIG. 4, the control unit 30 shifts a portion from the timing t23 of the changeover signal SW23 onward as a whole to the side of the timing t12 of the start of the processing period in the processing step as illustrated in 4C in FIG. 4. As a result, the control unit 30 shifts timing of the changeover signal SW23′ from the timing t23 to the timing t23′ which precedes the timing t23 by the time ΔTsw. The time ΔTsw has a length equivalent to a largest delay time among delay time values of respective processing conditions (for example, in the case of 4A in FIG. 4, the delay time Tesc for the temperature of the stage 11).

Furthermore, the control unit 30 shifts timing of changeover of the level (RF power level) of the power supply 20 or 80, from the level PW2 to the level PW3 from the timing t23″ to the timing t23. The control unit 30 shifts timing of starting a preparation operation for changeover of the flow rate of the processing gas from the flow rate F2 to the flow rate F4 (that is, a response to the changeover signal conducted by the gas flow rate control unit 32) from the timing t23mfc″ to the timing t23mfc, and shifts timing of starting the changeover from the flow rate F2 to the flow rate F4, from the timing t23″ to the timing t23. The control unit 30 shifts timing of starting a preparation operation for changeover of the pressure in the processing chamber 90 from the pressure P2 to the pressure P4 (that is, a response to the changeover signal conducted by the pressure control unit 33) from the timing t23apc″ to the timing t23apc, and shifts timing of starting the changeover from the pressure P2 to the pressure P4, from the timing t23″ to the timing t23. The control unit 30 shifts timing of starting a preparation operation for changeover of the temperature of the stage 11 from the temperature T2 to the temperature T4 (that is, a response to the changeover signal conducted by the temperature control unit 34) from the timing t23esc″ to the timing t23esc, and shifts timing of starting the changeover from the temperature T2 to the temperature T4, from the timing t23″ to the timing t23.

For example, in each waveform of the changeover signal, the power supply, the gas flow rate, the pressure, and the temperature as illustrated in 4B in FIG. 4, the control unit 30 shifts a portion after the timing t45 of the changeover signal SW45 as a whole to the side of the timing t34 of the start of the processing period as illustrated in 4C in FIG. 4. As a result, the control unit 30 shifts timing of the changeover signal SW45′ from the timing t45 to the timing t45′ which precedes the timing t45 by the time ΔTsw. The time ΔTsw has a length equivalent to a largest delay time among delay time values of respective processing conditions (for example, in the case of 4A in FIG. 4, the delay time Tesc for the temperature of the stage 11).

Furthermore, the control unit 30 shifts timing of changeover of the level (RF power level) of the power supply 20 or 80 from the level PW4 to the level PW5, from the timing t45″ to the timing t45. The control unit 30 shifts timing of starting a preparation operation for changeover of the flow rate of the processing gas from the flow rate F4 to the flow rate F6 (that is, a response to the changeover signal conducted by the gas flow rate control unit 32) from the timing t45mfc″ to the timing t45mfc, and shifts timing of starting the changeover from the flow rate F4 to the flow rate F6, from the timing t45″ to the timing t45. The control unit 30 shifts timing of starting a preparation operation for changeover of the pressure in the processing chamber 90 from the pressure P4 to the pressure P6 (that is, a response to the changeover signal conducted by the pressure control unit 33) from the timing t45apc″ to the timing t45apc, and shifts timing of starting the changeover from the pressure P4 to the pressure P6, from the timing t45″ to the timing t45. The control unit 30 shifts timing of starting a preparation operation for changeover of the temperature of the stage 11 from the temperature T4 to the temperature T6 (that is, a response to the changeover signal conducted by the temperature control unit 34) from the timing t45esc″ to the timing t45esc, and shifts timing of starting the changeover from the temperature T4 to the temperature T6, from the timing t45″ to the timing t45.

As described above, in the first embodiment, the control unit 30 in the substrate processing apparatus 1 exercises control to start a preparation operation (that is, a response to the changeover signal) in a period over which power supplied from the power supply 20 or 80 is kept at a first level corresponding to a first processing condition, that is, before timing of changeover of the power from the first level to a second level, as described heretofore. This preparation operation is an operation conducted as preparation to change over other processing parameters different from the power, from a level corresponding to the first processing condition to a level corresponding to a second processing condition. As a result, substrate processing under the first processing condition and a preparation operation for changeover of processing parameters to a level corresponding to the second processing condition can be conducted in parallel. When the substrate processing under the first processing condition is completed, the changeover of the processing parameters to a level corresponding to the second processing condition can be started immediately. As a result, time required to change over the processing condition from the first processing condition to the second processing condition (that is, the stability period) can be shortened.

For example, the control unit 30 exercises control to cause the substrate processing unit 40 to start a preparation operation (that is, a response to the changeover signal) for changeover of other processing parameters (for example, the gas flow rate, the pressure, and the temperature) to a level corresponding to the second processing condition, before timing of start of a stability period provided to stabilize the second processing condition. As a result, the substrate processing under the first processing condition and the preparation operation for changeover of the processing parameters to a level corresponding to the second processing condition can be conducted in parallel immediately before the stability period starts, and changeover of the processing parameters to the level corresponding to the second processing condition can be started immediately when the stability period has started.

Furthermore, in the first embodiment, the control unit 30 in the substrate processing apparatus 1 adjusts timing of starting the preparation operation (that is, a response to the changeover signal) to cause the substrate processing unit 40 to start changeover of other processing parameters (for example, the gas flow rate, the pressure, and the temperature) at the timing of changeover of power (one of the processing parameters) of the power supply 20 or 80 or later. This preparation operation is an operation conducted as preparation to change over other processing parameters different from the power, from a level corresponding to the first processing condition to a level corresponding to a second processing condition. As a result, changeover to the second processing condition can be started in synchronism with completion of the substrate processing under the first processing condition, and time required to change over the processing condition from the first processing condition to the second processing condition (that is, the stability period) can be shortened efficiently.

For example, the control unit 30 adjusts timing of starting a preparation (that is, a response to the changeover signal) to cause the substrate processing unit 40 to start changeover of other processing parameters at the timing of start of the stability period or later. As a result, changeover of other processing parameters to a level corresponding to the second processing condition can be started in synchronism with start of the stability period, and time required for changeover of the processing condition from the first processing condition to the second processing condition can be shortened efficiently.

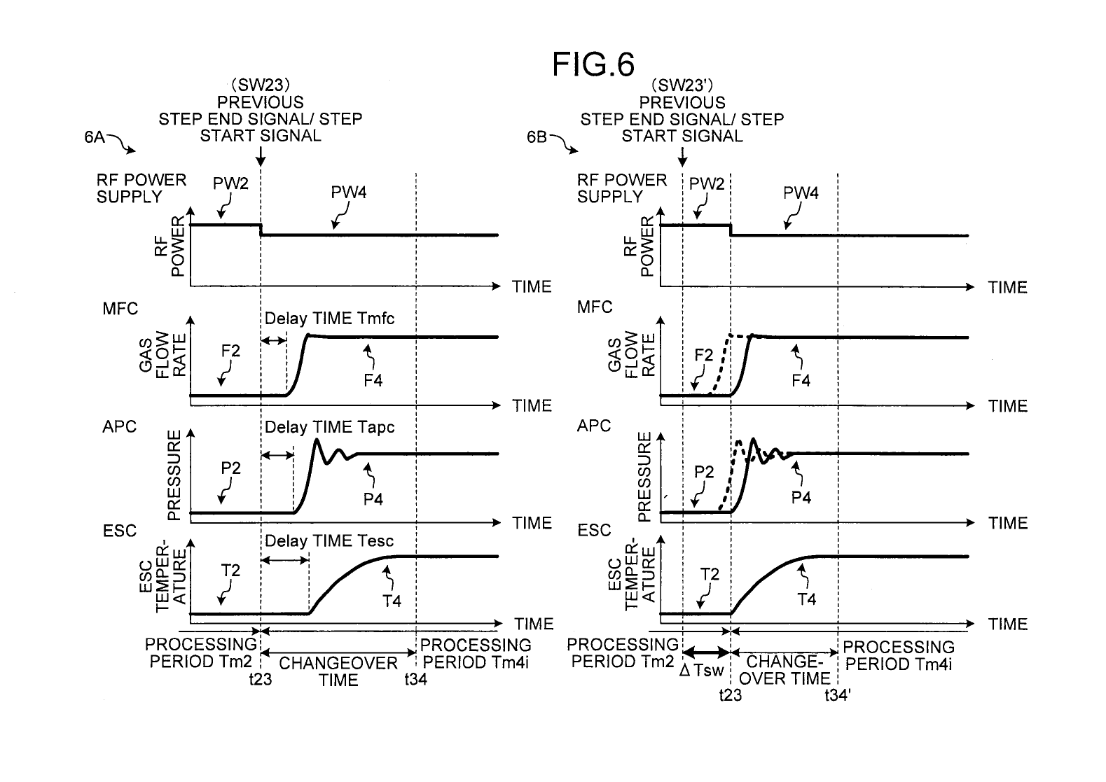

It should be noted that, although the stability period to suspend plasma discharge and stabilize the processing condition is provided before the processing period to conduct process on respective layers and plasma is discharged intermittently in the first embodiment, plasma may be discharged continuously. For example, as illustrated in 6A in FIG. 6, the stability period Tst3 (see 3A in FIG. 3) is not provided, and a processing period Tm4i to process the layer 2 is provided next to the processing period Tm2 to process the layer 1. For example, the power control unit 31 changes over the power of the power supply 20 or 80 from the level PW2 to the level PW4 in synchronism with the previous step end signal (the changeover signal SW23). The level PW2 is a level of power corresponding to the processing condition of the layer 1. The level PW4 is a level of power corresponding to the processing condition of the layer 2. At this time, time from the timing t23 of the changeover signal SW23 to timing t34 of stabilization of all of the gas flow rate, the pressure, and the stage temperature is changeover time.

In this case as well, for example, the control unit 30 corrects operation illustrated in 6A in FIG. 6 to operation illustrated in 6B in FIG. 6. More specifically, the gas flow rate control unit 32 exercises control to cause the gas flow rate adjustment unit 50 to start a preparation operation for changeover of the flow rate of the processing gas from the flow rate F2 to the flow rate F4 (that is, a response to a changeover signal) before the timing t23 of changeover of the power supply 20 or 80 from the level PW2 to the level PW4. The pressure control unit 33 exercises control to cause the pressure adjustment unit 60 to start a preparation operation for changeover of the pressure in the processing chamber 90 from the pressure P2 to the pressure P4 (that is, a response to a changeover signal) before the timing t23 of changeover of the power supply 20 or 80 from the level PW2 to the level PW4. The temperature control unit 34 exercises control to cause the temperature adjustment unit 70 to start a preparation operation for changeover of the temperature of the stage 11 from the temperature T2 to the temperature T4 (that is, a response to a changeover signal) before the timing t23 of changeover of the power supply 20 or 80 from the level PW2 to the level PW4.

In this way, the control unit 30 exercises control to start a preparation operation (that is, a response to the changeover signal) before timing of changeover of the power supply 20 or 80 from a level corresponding to the first processing condition to a level corresponding to the second processing condition. This preparation operation is an operation conducted as preparation to change over other processing parameters different from the power, from a level corresponding to the first processing condition to a level corresponding to a second processing condition. As a result, changeover of the processing parameters to a level corresponding to the second processing condition can be started in synchronism with completion of the substrate processing under the first processing condition, and time required to change over the processing condition from the first processing condition to the second processing condition (that is, the changeover time) can be shortened efficiently. That is, a period during which each processing parameter is unstable in the processing period Tm4i provided to process the layer 2 can be shortened and consequently, for example, the processing precision of the layer 2 can be improved.

Furthermore, for example, the delay correction unit 32b in the gas flow rate control unit 32 adjusts the timing t23mfc of starting a preparation operation (that is, a response to the changeover signal) for changeover from the flow rate F2 to the flow rate F4 conducted by the gas flow rate adjustment unit 50 to cause the gas flow rate adjustment unit 50 to start changeover from the flow rate F2 to the flow rate F4 at the timing t23 of the changeover of the power supply 20 or 80 or later (for example, at the same time as the timing 23). The delay correction unit 33b in the pressure control unit 33 adjusts the timing t23apc of starting a preparation operation for changeover from the pressure P2 to the pressure P4 conducted by the pressure adjustment unit 60 (that is, a response to the changeover signal) to cause timing of starting changeover from the pressure P2 to the pressure P4 conducted by the pressure adjustment unit 60 to become the timing t23 of the changeover of the power supply 20 or 80 or later (for example, at the same time as the timing t23). The delay correction unit 34b in the temperature control unit 34 adjusts the timing t23esc of starting a preparation operation for changeover from the temperature T2 to the temperature T4 conducted by the temperature adjustment unit 70 (that is, a response to the changeover signal) to cause timing of starting changeover from the temperature T2 to the temperature T4 conducted by the temperature adjustment unit 70 to become the timing t23 of the changeover of the power supply 20 or 80 or later (for example, at the same time as the timing t23).

In this way, the control unit 30 adjusts timing of starting the preparation operation (that is, a response to the changeover signal) to cause the substrate processing unit 40 to start changeover of other processing parameters (for example, the gas flow rate, the pressure, and the temperature) to a level corresponding to the second processing condition at timing of changeover of power (one of the processing parameters) of the power supply 20 or 80 or later. As a result, changeover of other processing parameters to a level corresponding to the second processing condition can be started in synchronism with completion of the substrate processing under the first processing condition, and time required to change over the processing condition from the first processing condition to the second processing condition (that is, the changeover time) can be shortened efficiently.

Or in the first embodiment, the case where the substrate processing unit 40 conducts plasma processing and conducts etching processing (for example, RIE) has been described as an example. However, the concept of the first embodiment can be applied even if the substrate processing unit 40 conducts plasma processing and continuous film forming processing (for example, plasma CVD). Or the concept of the first embodiment can be applied even if the substrate processing unit 40 conducts processing other than plasma processing and conducts continuous film forming processing (such as, for example, thermal CVD, optical CVD, epitaxial CVD, atomic layer CVD, MOCVD, resistance heating evaporation, electronic beam evaporation, molecular beam epitaxy, ion plating, ion beam deposition, or sputtering).

### Second Embodiment

A substrate processing apparatus 100 according to a second embodiment will now be described. Hereafter, portions different from the first embodiment will be described mainly.

In the first embodiment, the case where the delay time at each step can be regarded as constant is supposed and each of the delay correction units 31b, 32b, 33b, and 34b conducts constant correction. In the second embodiment, however, each of delay correction units 131b, 132b, 133b, and 134b are improved to be capable of coping with the case where the delay time at each step differs.

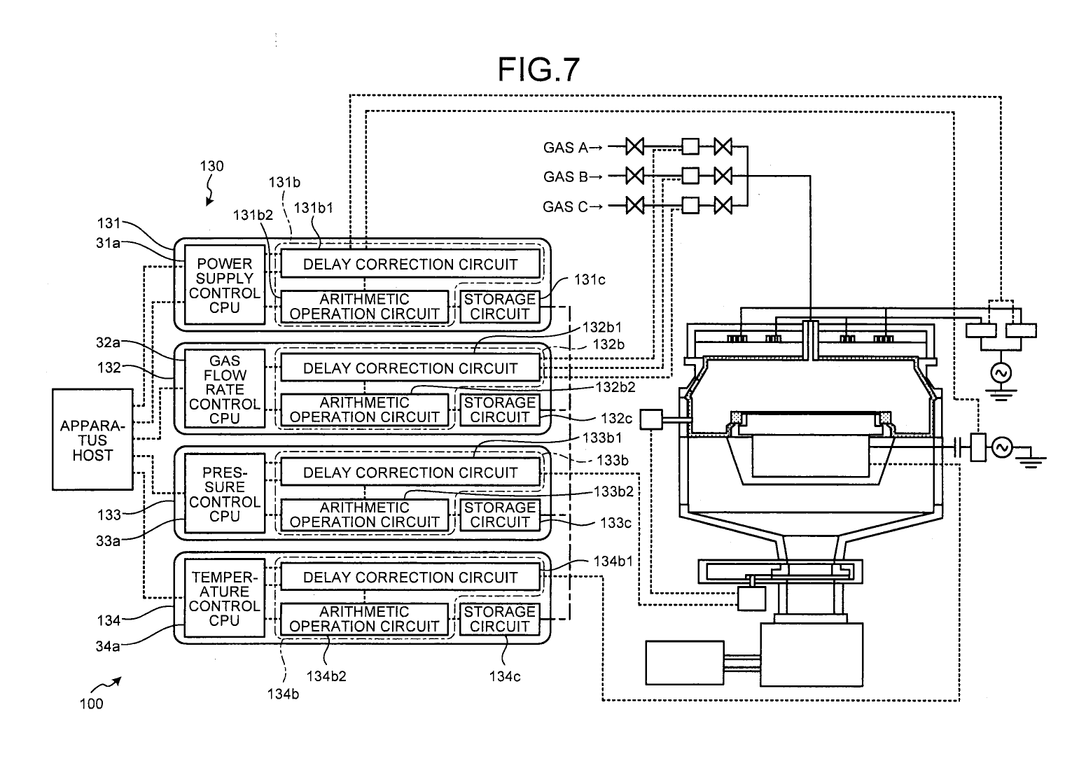

Specifically, a control unit 130 in the substrate processing apparatus 100 includes a power supply control unit 131, a gas flow rate control unit 132, a pressure control unit 133, and a temperature control unit 134 as illustrated in FIG. 7 instead of the power supply control unit 31, the gas flow rate control unit 32, the pressure control unit 33, and the temperature control unit 34 (see FIG. 1). FIG. 7 is a diagram illustrating a configuration of the substrate processing apparatus 100.

The power supply control unit 131 includes a delay correction unit 131b instead of the delay correction unit 31b (see FIG. 1), and further includes a storage circuit (storage unit) 131c. The delay correction unit 131b includes a delay correction circuit 131b1 and an arithmetic operation circuit 131b2. Delay information 131c1 concerning delay time of the power supply 20 or 80 at the time of changeover from the first processing condition to the second processing condition is stored in the storage circuit 131c.

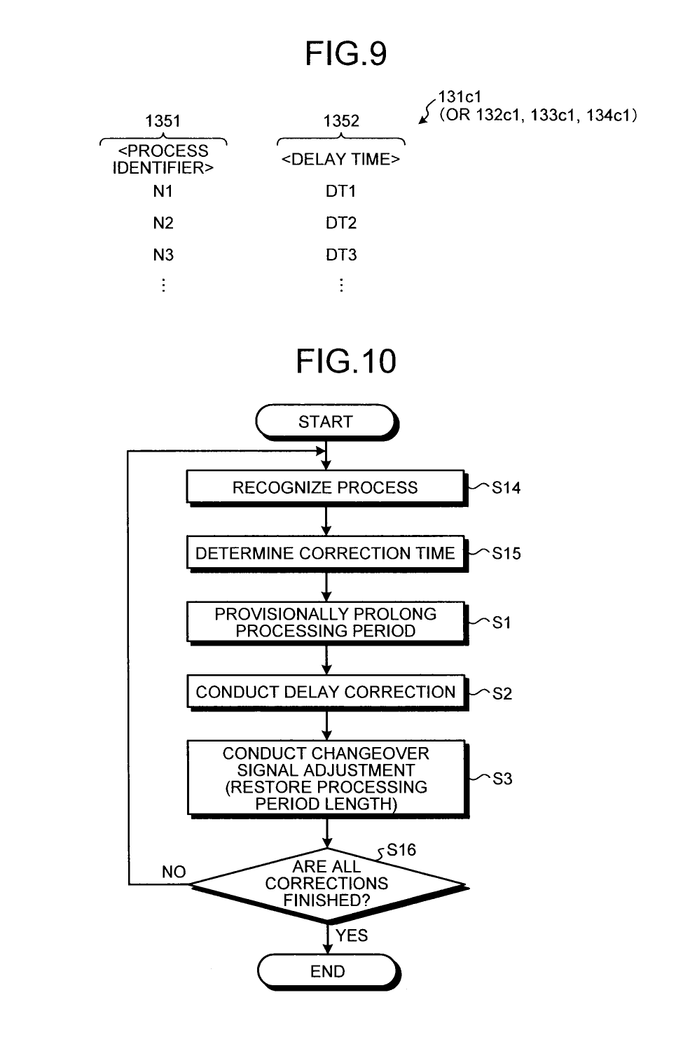

In the delay information 131c1, each process identifier included in a plurality of process identifiers is associated with a delay time. The delay information 131c1 includes a process identifier column 1351 and a delay time column 1352, for example, as illustrated in FIG. 9. FIG. 9 is a diagram illustrating a data structure of the delay information 131c1. In the process identifier column 1351, process identifiers (for example, process numbers) N1, N2, N3, . . . are recorded. In the delay time column 1352, delay time DT1, DT2, DT3, . . . are recorded. It is found that the delay time of the power supply 20 or 80 in changeover to the process identifier N1 is DT1, the delay time of the power supply 20 or 80 in changeover to the process identifier N2 is DT2, and the delay time of the power supply 20 or 80 in changeover to the process identifier N3 is DT3 by referring to the delay information 131c1.

It should be noted that, in a case where the delay time of the power supply 20 or 80 can be neglected, DT1=0, DT2=0 and DT3=0 are set.

The arithmetic operation circuit 131b2 recognizes a current process identifier, and identifies delay time (≈0) corresponding to the current process identifier by referring to the delay information 131c1 in the storage circuit 131c. Furthermore, the arithmetic operation circuit 131b2 refers to delay information in the storage circuits 131c, 132c, 133c, and 134c, and identifies a largest delay time among delay time values in the processing conditions as time ΔTsw to be used to shift the timing of the changeover signal. The arithmetic operation circuit 131b2 computes the correction time ΔTpw by using, for example, Expression 1 on the basis of the identified delay time (≈0) and the time ΔTsw, and supplies the correction time ΔTpw to the delay correction circuit 131b1. The delay correction circuit 131b1 conducts correction in similar way to the delay correction unit 31b in the first embodiment by using the correction time ΔTpw.

The gas flow rate control unit 132 includes a delay correction unit 132b instead of the delay correction unit 32b (see FIG. 1), and further includes a storage circuit (storage unit) 132c. The delay correction unit 132b includes a delay correction circuit 132b1 and an arithmetic operation circuit 132b2. Delay information 132c1 concerning delay time of the gas flow rate adjustment unit 50 at the time of changeover from the first processing condition to the second processing condition is stored in the storage circuit 132c.

In the delay information 132c1, each process identifier included in a plurality of process identifiers is associated with a delay time. The delay information 132c1 has, for example, a data structure as illustrated in FIG. 9. It is found that the delay time of the gas flow rate adjustment unit 50 in changeover to the process identifier N1 is DT1, the delay time of the gas flow rate adjustment unit 50 in changeover to the process identifier N2 is DT2, and the delay time of the gas flow rate adjustment unit 50 in changeover to the process identifier N3 is DT3 by referring to the delay information 132c1.

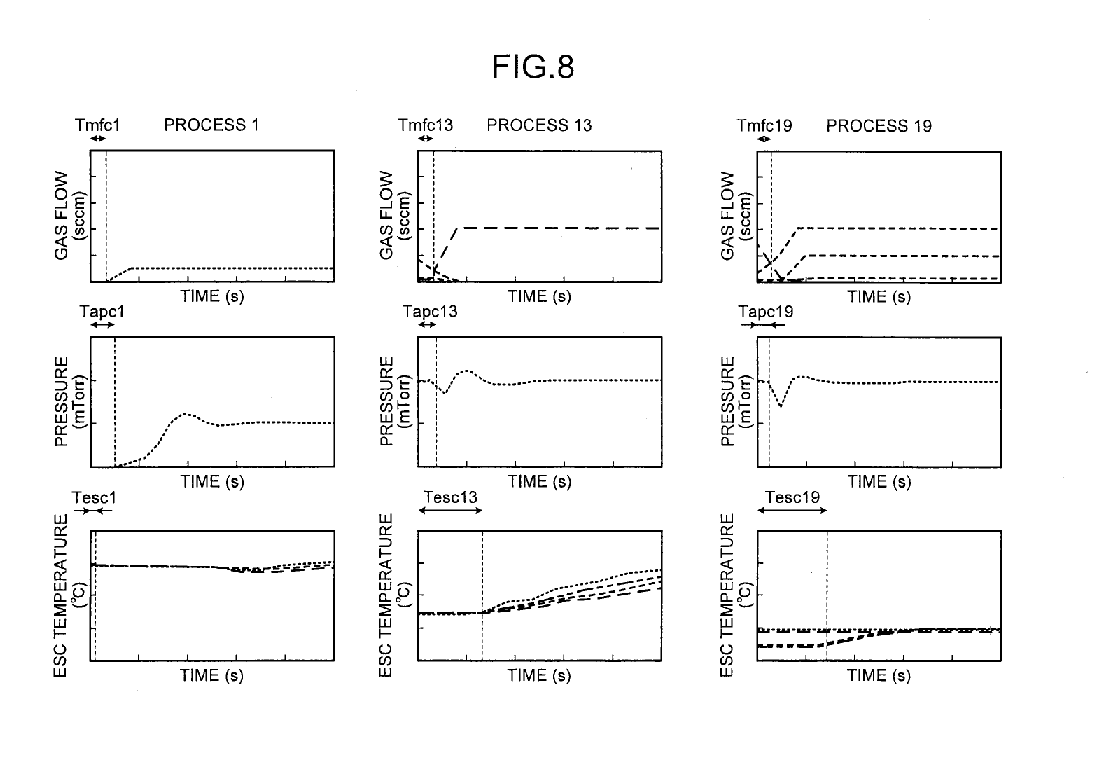

It should be noted that the delay information stored in the storage circuit 132c can be acquired experimentally, for example, as illustrated in FIG. 8. For example, delay time DT1=Tmfc1 of the gas flow rate adjustment unit 50 in changeover to process identifier N1=process 1 is acquired. Delay time DT2=Tmfc13 of the gas flow rate adjustment unit 50 in changeover to process identifier N2=process 13 is acquired. Delay time DT3=Tmfc19 of the gas flow rate adjustment unit 50 in changeover to process identifier N3=process 19 is acquired.

The arithmetic operation circuit 132b2 recognizes a current process identifier, and identifies delay time Tmfc corresponding to the current process identifier by referring to the delay information 132c1 in the storage circuit 132c. Furthermore, the arithmetic operation circuit 132b2 refers to delay information in the storage circuits 131c, 132c, 133c, and 134c, and identifies a largest delay time among delay time values in the processing conditions as time ΔTsw to be used to shift the timing of the changeover signal. The arithmetic operation circuit 132b2 computes the correction time ΔTmfc, for example, in similar way to Expression 2 on the basis of the identified delay time Tmfc and the time ΔTsw, and supplies the correction time ΔTmfc to the delay correction circuit 132b1. The delay correction circuit 132b1 conducts correction in similar way to the delay correction unit 32b in the first embodiment by using the correction time ΔTmfc.

The pressure control unit 133 includes a delay correction unit 133b instead of the delay correction unit 33b (see FIG. 1), and further includes a storage circuit (storage unit) 133c. The delay correction unit 133b includes a delay correction circuit 133b1 and an arithmetic operation circuit 133b2. Delay information 133c1 concerning delay time of the pressure adjustment unit 60 at the time of changeover from the first processing condition to the second processing condition is stored in the storage circuit 133c.

In the delay information 133c1, each process identifier included in a plurality of process identifiers is associated with a delay time. The delay information 133c1 has, for example, a data structure as illustrated in FIG. 9. It is found that the delay time of the pressure adjustment unit 60 in changeover to the process identifier N1 is DT1, the delay time of the pressure adjustment unit 60 in changeover to the process identifier N2 is DT2, and the delay time of the pressure adjustment unit 60 in changeover to the process identifier N3 is DT3 by referring to the delay information 133c1.

It should be noted that the delay information stored in the storage circuit 133c can be acquired experimentally, for example, as illustrated in FIG. 8. For example, delay time DT1=Tapc1 of the pressure adjustment unit 60 in changeover to process identifier N1=process 1 is acquired. Delay time DT2=Tapc13 of the pressure adjustment unit 60 in changeover to process identifier N2=process 13 is acquired. Delay time DT3=Tapc19 of the pressure adjustment unit 60 in changeover to process identifier N3=process 19 is acquired.

The arithmetic operation circuit 133b2 recognizes a current process identifier, and identifies delay time Tapc corresponding to the current process identifier by referring to the delay information 133c1 in the storage circuit 133c. Furthermore, the arithmetic operation circuit 133b2 refers to delay information in the storage circuits 131c, 132c, 133c, and 134c, and identifies a largest delay time among delay time values in the processing conditions as time ΔTsw to be used to shift the timing of the changeover signal. The arithmetic operation circuit 133b2 computes the correction time ΔTapc, for example, in the same way as Expression 3 on the basis of the identified delay time Tapc and the time ΔTsw, and supplies the correction time ΔTapc to the delay correction circuit 133b1. The delay correction circuit 133b1 conducts correction in the same way as the delay correction unit 33b in the first embodiment by using the correction time ΔTapc.

The temperature control unit 134 includes a delay correction unit 134b instead of the delay correction unit 34b (see FIG. 1), and further includes a storage circuit (storage unit) 134c. The delay correction unit 134b includes a delay correction circuit 134b1 and an arithmetic operation circuit 134b2. Delay information 134c1 concerning delay time of the temperature adjustment unit 70 at the time of changeover from the first processing condition to the second processing condition is stored in the storage circuit 134c.

In the delay information 134c1, each process identifier included in a plurality of process identifiers is associated with a delay time. The delay information 134c1 has, for example, a data structure as illustrated in FIG. 9. It is found that the delay time of the temperature adjustment unit 70 in changeover to the process identifier N1 is DT1, the delay time of the temperature adjustment unit 70 in changeover to the process identifier N2 is DT2, and the delay time of the temperature adjustment unit 70 in changeover to the process identifier N3 is DT3 by referring to the delay information 134c1.

It should be noted that the delay information stored in the storage circuit 134c can be acquired experimentally, for example, as illustrated in FIG. 8. For example, delay time DT1=Tesc1 of the temperature adjustment unit 70 in changeover to process identifier N1=process 1 is acquired. Delay time DT2=Tesc13 of the temperature adjustment unit 70 in changeover to process identifier N2=process 13 is acquired. Delay time DT3=Tesc19 of the temperature adjustment unit 70 in changeover to process identifier N3=process 19 is acquired.

The arithmetic operation circuit 134b2 recognizes a current process identifier, and identifies delay time Tesc corresponding to the current process identifier by referring to the delay information 134c1 in the storage circuit 134c. Furthermore, the arithmetic operation circuit 134b2 refers to delay information in the storage circuits 131c, 132c, 133c, and 134c, and identifies a largest delay time among delay time values in the processing conditions as time ΔTsw to be used to shift the timing of the changeover signal. The arithmetic operation circuit 134b2 computes the correction time ΔTesc, for example, in the same way as Expression 4 on the basis of the identified delay time Tesc and the time ΔTsw, and supplies the correction time ΔTesc to the delay correction circuit 134b1. The delay correction circuit 134b1 conducts correction in the same way as the delay correction unit 34b in the first embodiment by using the correction time ΔTesc.

Furthermore, a concrete correction operation of the substrate processing apparatus 100 differs from the first embodiment in the following points as illustrated in FIG. 10.

At step S14, the control unit 130 recognizes a current process identifier. For example, the control unit 130 recognizes “process 2” as the current process identifier during the processing period Tm2 (see 2B in FIG. 2). The control unit 130 may recognize the current process identifier by inquiring of the apparatus host 180 and receiving a response thereof.

At step S15, the control unit 130 refers to the delay information and determines correction time in accordance with the delay information.

For example, the control unit 130 refers to the delay information 132c1 in the storage circuit 131c with respect to the level (RF power level) of the power supply 20 or 80, and identifies delay time (≈0) corresponding to the current process identifier. Furthermore, the control unit 130 refers to delay information in the storage circuits 131c, 132c, 133c, and 134c, and identifies a largest time among delay time values under process conditions as time ΔTsw to be used to shift the timing of the changeover signal. The control unit 130 computes correction time ΔTpw by using, for example, Expression 1 on the basis of the identified delay time (≈0) and the time ΔTsw. As a result, the control unit 130 determines the correction time ΔTpw.

Furthermore, for example, the control unit 130 refers to the delay information 132c1 in the storage circuit 132c with respect to the flow rate of the processing gas, and identifies delay time Tmfc corresponding to the current process identifier. Furthermore, the control unit 130 refers to delay information in the storage circuits 131c, 132c, 133c, and 134c, and identifies a largest time among delay time values under process conditions as time ΔTsw to be used to shift the timing of the changeover signal. The control unit 130 computes correction time ΔTmfc, for example, in similar way to Expression 2 on the basis of the identified delay time Tmfc and the time ΔTsw. As a result, the control unit 130 determines the correction time ΔTmfc.

Furthermore, for example, the control unit 130 refers to the delay information 133c1 in the storage circuit 133c with respect to the pressure in the processing chamber 90, and identifies delay time Tapc corresponding to the current process identifier. Furthermore, the control unit 130 refers to delay information in the storage circuits 131c, 132c, 133c, and 134c, and identifies a largest time among delay time values under process conditions as time ΔTsw to be used to shift the timing of the changeover signal. The control unit 130 computes correction time ΔTapc, for example, in the same way as Expression 3 on the basis of the identified delay time Tapc and the time ΔTsw. As a result, the control unit 130 determines the correction time ΔTapc.

Furthermore, for example, the control unit 130 refers to the delay information 134c1 in the storage circuit 134c with respect to the temperature of the stage 11, and identifies delay time Tesc corresponding to the current process identifier. Furthermore, the control unit 130 refers to delay information in the storage circuits 131c, 132c, 133c, and 134c, and identifies a largest time among delay time values under process conditions as time ΔTsw to be used to shift the timing of the changeover signal. The control unit 130 computes correction time ΔTesc, for example, in the same way as Expression 4 on the basis of the identified delay time Tesc and the time ΔTsw. As a result, the control unit 130 determines the correction time ΔTesc.

At step S16, the control unit 130 determines whether the processing at the step S14 to the step S3 has been conducted with respect to all adjacent processes to be corrected in delay time. In a case where processing has not been conducted between all adjacent processes (No at the step S16), the control unit 130 returns the processing to the step S14. In a case where processing has been conducted between all adjacent processes (Yes at the step S16), the control unit 130 finishes the processing.

As described above, in the second embodiment, the storage circuits 131c, 132c, 133c, and 134c in the control unit 130 in the substrate processing apparatus 100 store delay information concerning delay time in the substrate processing unit 40 at the time of changeover from the first processing condition to the second processing condition as described heretofore. The delay correction units 131b, 132b, 133b, and 134b adjusts timing of starting a preparation operation of changeover (that is, a response to the changeover signal) to precede the timing of changeover of the power supply 20 or 80 in accordance with the delay information stored in the storage circuits 131c, 132c, 133c, and 134c. As a result, timing of starting the preparation operation for changeover can be adjusted considering the delay time for changeover to the next processing condition. In a case where delay time is not constant for different changeover between processes, the time required for changeover of the processing condition (that is, the stability period) can be shortened.

### Third Embodiment

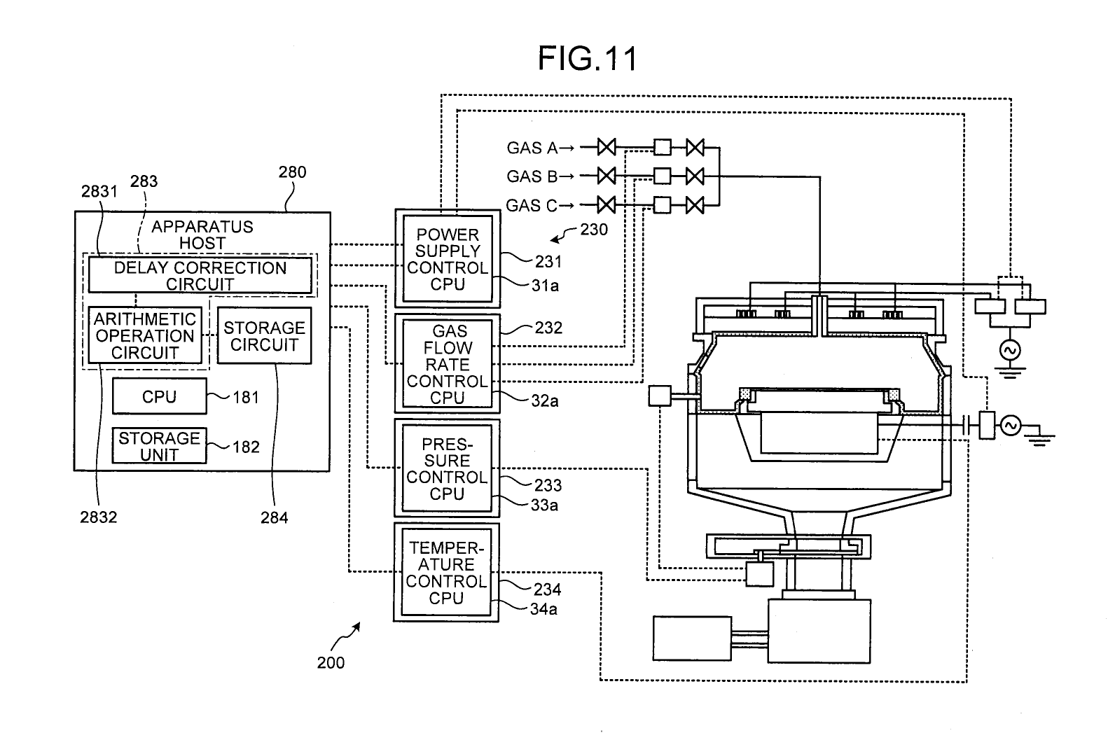

A substrate processing apparatus 200 according to a third embodiment as illustrated in FIG. 11 will now be described. Hereafter, portions different from the second embodiment will be described mainly.

In the second embodiment, arithmetic operation of the correction time concerning changeover between processes is conducted on the side of the control unit 130. In the third embodiment, however, the arithmetic operation of the correction time is conducted on the side of an apparatus host 280.

Specifically, a control unit 230 in the substrate processing apparatus 200 includes a power supply control unit 231, a gas flow rate control unit 232, a pressure control unit 233, and a temperature control unit 234 as illustrated in FIG. 11 instead of the power supply control unit 131, the gas flow rate control unit 132, the pressure control unit 133, and the temperature control unit 134 (see FIG. 7). In the second embodiment, a delay correction unit 283 and a storage circuit 284 are provided in each of the power supply control unit 131, the gas flow rate control unit 132, the pressure control unit 133, and the temperature control unit 134 as illustrated in FIG. 7. In the third embodiment, however, the delay correction unit 283 and the storage circuit 284 are provided in the apparatus host 280 as illustrated in FIG. 11. Accordingly, each of the power supply control unit 231, the gas flow rate control unit 232, the pressure control unit 233, and the temperature control unit 234 has a configuration in which the delay correction unit and the storage circuit are omitted.

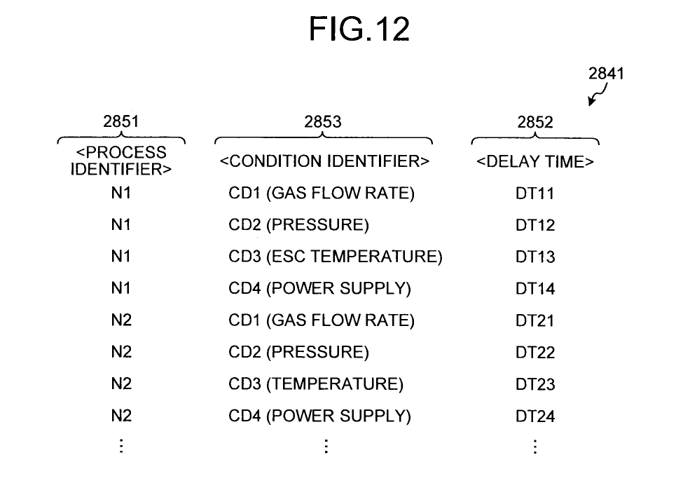

Operation of the delay correction unit 283 and the storage circuit 284 is basically the same as the second embodiment. However, a data structure of delay information 2841 stored in the storage circuit 284 differs from the second embodiment as illustrated in FIG. 12.

In the delay information 2841, a process identifier, a condition identifier, and a delay time are associated with each other with respect to a plurality of process identifiers and a plurality of condition identifiers. The delay information includes a process identifier column 2851, a condition identifier column 2853, and a delay time column 2852, for example, as illustrated in FIG. 12. FIG. 12 is a diagram illustrating a data structure of the delay information 2841. Process identifiers (for example, process numbers) N1, N2, . . . are recorded in the process identifier column 2851. Condition identifiers CD1, CD2, CD3, CD4, . . . are recorded in the condition identifier column 2853. Delay time DT11, DT12, DT13, DT14, DT21, DT22, DT23, DT24, . . . are recorded in the delay time column 2852. It is found that delay time of the condition identifier CD1 (gas flow rate) in changeover to the process identifier N1 is DT11, delay time of the condition identifier CD2 (pressure) in changeover to the process identifier N1 is DT12, delay time of the condition identifier CD3 (ESC temperature) in changeover to the process identifier N1 is DT13, and delay time of the condition identifier CD4 (power supply) in changeover to the process identifier N1 is DT14 by referring to the delay information 2841. It is found that delay time of the condition identifier CD1 (gas flow rate) in changeover to the process identifier N2 is DT21, delay time of the condition identifier CD2 (pressure) in changeover to the process identifier N2 is DT22, delay time of the condition identifier CD3 (ESC temperature) in changeover to the process identifier N2 is DT23, and delay time of the condition identifier CD4 (power supply) in changeover to the process identifier N2 is DT24 by referring to the delay information 2841.

The delay correction unit 283 includes a delay correction circuit 2831 and an arithmetic operation circuit 2832.

The arithmetic operation circuit 2832 recognizes a current process identifier, refers to the delay information 2841 in the storage circuit 284 with respect to the level (RF power level) of the power supply, and identifies delay time (≈0) corresponding to the current process identifier. Furthermore, the arithmetic operation circuit 2832 refers to the delay information 2841 in the storage circuit 284, and identifies largest delay time among delay time values under respective process conditions as time ΔTsw to be used to shift timing of the changeover signal. The arithmetic operation circuit 2832 computes the correction time ΔTpw by using, for example, Expression 1 on the basis of the identified delay time (≈0) and the time ΔTsw, and supplies the correction time ΔTpw to the delay correction circuit 2831. The delay correction circuit 2831 conducts correction in the same way as the delay correction unit 31b in the first embodiment by using the correction time ΔTpw, and transmits a correction result (correction information) to the power supply control unit 231. As a result, the power supply control unit 231 receives the correction result (correction information), and controls the power supply 20 or 80 in the same way as the first embodiment in accordance with the received correction result (correction information).

Furthermore, the arithmetic operation circuit 2832 refers to the delay information 2841 in the storage circuit 284, and identifies delay time Tmfc corresponding to the current process identifier. Furthermore, the arithmetic operation circuit 2832 refers to the delay information 2841 in the storage circuit 284, and identifies largest delay time among delay time values under respective process conditions as time ΔTsw to be used to shift timing of the changeover signal. The arithmetic operation circuit 2832 computes the correction time ΔTmfc, for example, in the same way as Expression 2 on the basis of the identified delay time Tmfc and the time ΔTsw, and supplies the correction time ΔTmfc to the delay correction circuit 2831. The delay correction circuit 2831 conducts correction in the same way as the delay correction unit 32b in the first embodiment by using the correction time ΔTmfc, and transmits a correction result (correction information) to the gas flow rate control unit 232. As a result, the gas flow rate control unit 232 receives the correction result (correction information), and controls the gas flow rate adjustment unit 50 in the same way as the first embodiment in accordance with the received correction result (correction information).

Furthermore, the arithmetic operation circuit 2832 refers to the delay information 2841 in the storage circuit 284, and identifies delay time Tapc corresponding to the current process identifier. Furthermore, the arithmetic operation circuit 2832 refers to the delay information 2841 in the storage circuit 284, and identifies largest delay time among delay time values under respective process conditions as time ΔTsw to be used to shift timing of the changeover signal. The arithmetic operation circuit 2832 computes the correction time ΔTapc, for example, in the same way as Expression 3 on the basis of the identified delay time Tapc and the time ΔTsw, and supplies the correction time ΔTapc to the delay correction circuit 2831. The delay correction circuit 2831 conducts correction in the same way as the delay correction unit 33b in the first embodiment by using the correction time ΔTapc, and transmits a correction result (correction information) to the pressure control unit 233. As a result, the pressure control unit 233 receives the correction result (correction information), and controls the pressure adjustment unit 60 in the same way as the first embodiment in accordance with the received correction result (correction information).

Furthermore, the arithmetic operation circuit 2832 refers to the delay information 2841 in the storage circuit 284, and identifies delay time Tesc corresponding to the current process identifier. Furthermore, the arithmetic operation circuit 2832 refers to the delay information 2841 in the storage circuit 284, and identifies largest delay time among delay time values under respective process conditions as time ΔTsw to be used to shift timing of the changeover signal. The arithmetic operation circuit 2832 computes the correction time ΔTesc, for example, in the same way as Expression 4 on the basis of the identified delay time Tesc and the time ΔTsw, and supplies the correction time ΔTesc to the delay correction circuit 2831. The delay correction circuit 2831 conducts correction in the same way as the delay correction unit 34b in the first embodiment by using the correction time ΔTesc, and transmits a correction result (correction information) to the temperature control unit 234. As a result, the temperature control unit 234 receives the correction result (correction information), and controls the temperature adjustment unit 70 in the same way as the first embodiment in accordance with the received correction result (correction information).

As described above, in the third embodiment, the storage circuit 284 in the apparatus host 280 stores delay information concerning delay time in the substrate processing unit 40 at the time of changeover from the first processing condition to the second processing condition as described heretofore. The delay correction unit 283 obtains a correction result by adjusting timing of starting a preparation operation for changeover (that is, a response to the changeover signal) to precede the timing of changeover of power of the power supply 20 or 80 in accordance with delay information stored in the storage circuit 284, and transmits the correction result to the control unit 230. As a result, the control unit 230 can control timing of the starting preparation operation for changeover (that is, the response to the changeover signal) considering delay time of changeover to the next processing condition. In the case where delay time in different changeover between processes is not constant, therefore, time required for changeover of the processing condition (that is, the stability period) can be shortened.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A substrate processing apparatus comprising:
a substrate processing unit configured to conduct processing on a substrate successively under first and second processing conditions each including a plurality of kinds of processing parameters to process the substrate;
a power supply capable of supplying power, which is one of the processing parameters included in each of the first and second processing conditions, to process the substrate; and
a control unit configured to, during a period over which power supplied from the power supply is kept at a first level corresponding to the first processing condition, start a preparation operation to change over other processing parameters different from the power, from a level corresponding to the first processing condition to a level corresponding to the second processing condition.

2. The substrate processing apparatus according to claim 1, wherein
the control unit receives a changeover signal from a host before timing of changeover of the power supplied from the power supply from the first level to a second level,
the preparation operation includes a conversion operation to convert the received changeover signal to a signal form that can be recognized by the control unit, and
the control unit starts the conversion operation before the timing of the changeover of the power supplied from the power supply from the first level to the second level.

3. The substrate processing apparatus according to claim 1, wherein
the control unit adjusts timing for the control unit to start the preparation operation to cause the control unit to finish the preparation operation and the substrate processing unit to start the changeover of other processing parameters, at timing of changeover of the power supplied from the power supply from the first level to a second level, or later.

4. The substrate processing apparatus according to claim 3, wherein
the control unit adjusts the timing for the control unit to start the preparation operation to cause start of the changeover of a plurality of other processing parameters to synchronize with the timing of the changeover of the power supplied from the power supply from the first level to the second level.

5. The substrate processing apparatus according to claim 3, wherein
the control unit receives a changeover signal from a host before timing of changeover of the power supplied from the power supply from the first level to the second level,
the preparation operation includes a conversion operation to convert the received changeover signal to a signal form that can be recognized by the control unit, and
the control unit adjusts time from the timing of receiving the changeover signal to timing of starting the conversion operation to cause the control unit to finish the preparation operation and the substrate processing unit to start the changeover of other processing parameters, at the timing of changeover of the power supplied from the power supply from the first level to a second level, or later.

6. The substrate processing apparatus according to claim 5, wherein
the control unit adjusts correction time provided to delay the timing of starting the conversion operation from the timing of receiving the changeover signal from the host, in accordance with delay information concerning delay time from the start of the conversion operation to the start of the changeover of other processing parameters, required to conduct the preparation operation at time of changeover from processing under the first processing condition to processing under the second processing condition.

7. The substrate processing apparatus according to claim 6, wherein
the control unit comprises:
a storage unit configured to store the delay information; and
a correction unit configured to adjust correction time provided to delay the timing of starting the conversion operation from the timing of receiving the changeover signal from the host in accordance with the delay information stored in the storage unit.

8. The substrate processing apparatus according to claim 7, wherein
the correction unit adjusts the correction time to cause sum total of the correction time and the delay time to become at least time from the timing for the control unit to receive the changeover signal to timing of changeover of the power supply.

9. The substrate processing apparatus according to claim 8, wherein
the correction unit adjusts the correction time with respect to each of the plurality of other processing parameters to cause sum total of the correction time and the delay time to become at least time from the timing for the control unit to receive the changeover signal to timing of changeover of the power supply and cause the plurality of other processing parameters to synchronize in changeover start.

10. The substrate processing apparatus according to claim 6, wherein
the control unit receives correction information depending upon the delay information from the host, and adjusts the correction time provided to delay the timing of starting the conversion operation.

11. The substrate processing apparatus according to claim 10, wherein
the delay information includes information concerning delay time of each of the plurality of other processing parameters, and
the correction unit adjusts the correction time with respect to each of the plurality of other processing parameters to cause sum total of the correction time and the delay time to become at least time from the timing for the control unit to receive the changeover signal to timing of changeover of the power supply and cause the plurality of other processing parameters to synchronize in changeover start.

12. The substrate processing apparatus according to claim 1, wherein
the substrate processing unit comprises:
a processing chamber in which a stage configured to hold the substrate is disposed; and
a plasma generation unit configured to generated plasma in the processing chamber, and
the power supply is a radio frequency power supply configured to supply power to the plasma generation unit.

13. The substrate processing apparatus according to claim 12, wherein
the other processing parameters includes at least one of a flow rate of processing gas introduced into the processing chamber, pressure in the processing chamber, and temperature of the stage.

14. The substrate processing apparatus according to claim 12, wherein
the substrate processing apparatus conducts intermittent plasma discharge, the power supplied from the power supply is kept at the first level corresponding to the first processing condition and plasma discharge is conducted for a first processing period, the power supplied from the power supply is kept at a second level and plasma discharge is suspended for a stability period subsequent to the first processing period, and the power supplied from the power supply is kept at a third level corresponding to the second processing condition for a second processing period subsequent to the stability period, and
the control unit exercises control to cause the preparation operation to be started during the first processing period and cause the substrate processing unit to conduct the changeover of other processing parameters, at start timing of the stability period, or later.

15. The substrate processing apparatus according to claim 14, wherein
the control unit receives a changeover signal from a host before the start timing of the stability period,
the preparation operation includes a conversion operation to convert the received changeover signal to a signal form that can be recognized by the control unit, and
the control unit starts the conversion operation before the start timing of the stability period.

16. The substrate processing apparatus according to claim 14, wherein
the control unit adjusts timing for the control unit to start the preparation operation to cause the control unit to finish the preparation operation and the substrate processing unit to start the changeover of other processing parameters, at the start timing of the stability period, or later.

17. The substrate processing apparatus according to claim 12, wherein
the substrate processing apparatus conducts continuous plasma discharge, the power supplied from the power supply is kept at the first level corresponding to the first processing condition and plasma discharge is conducted for a first processing period, and the power supplied from the power supply is kept at a second level corresponding to the second processing condition for a second processing period subsequent to the first processing period, and
the control unit exercises control to cause the preparation operation to be started during the first processing period and cause the substrate processing unit to conduct the changeover of other processing parameters, at start timing of the second processing period, or later.

18. The substrate processing apparatus according to claim 17, wherein
the control unit receives a changeover signal from a host before the start timing of the second processing period,
the preparation operation includes a conversion operation to convert the received changeover signal to a signal form that can be recognized by the control unit, and
the control unit starts the conversion operation before the start timing of the second processing period.

19. The substrate processing apparatus according to claim 17, wherein
the control unit adjusts timing for the control unit to start the preparation operation to cause the control unit to finish the preparation operation and the substrate processing unit to start the changeover of other processing parameters, at the start timing of the second processing period, or later.

20. A control method in a substrate processing apparatus including a substrate processing unit configured to conduct processing on a substrate successively under first and second processing conditions each including a plurality of kinds of processing parameters to process the substrate, and a power supply capable of supplying power, which is one of the processing parameters included in each of the first and second processing conditions, to process the substrate, the control method comprising:
starting a preparation operation to, during a period over which power supplied from the power supply is kept at a first level corresponding to the first processing condition, change over other processing parameters different from the power, from a level corresponding to the first processing condition to a level corresponding to the second processing condition; and
finishing the preparation operation and causing the substrate processing unit to start changeover of other processing parameters, at timing of changeover of the power supplied from the power supply from the first level to a second level, or later.
